(19) United States
(12) Patent Application Publication
(10) Pub. No.: US 2013/0080966 A1
(43) Pub. Date: Mar. 28, 2013

(54) USER EXPERIENCE FOR NOTEBOOK CREATION AND INTERACTION

(71) Applicants: Erez Kikin-Gil, Redmond, WA (US); Maya Rodrig, Seattle, WA (US); Travis Mark Spomer, Redmond, WA (US); Anna Kaplunov, Redmond, WA (US); Aaron Alexander Selig, Seattle, WA (US)

(72) Inventors: Erez Kikin-Gil, Redmond, WA (US); Maya Rodrig, Seattle, WA (US); Travis Mark Spomer, Redmond, WA (US); Anna Kaplunov, Redmond, WA (US); Aaron Alexander Selig, Seattle, WA (US)

(73) Assignee: Microsoft Corporation, Redmond, WA (US)

(21) Appl. No.: 13/405,369

(22) Filed: Feb. 27, 2012

Related U.S. Application Data
(60) Provisional application No. 61/537,938, filed on Sep. 22, 2011.

(51) Int. Cl. G06F 3/048

(52) U.S. Cl. 715/776

(57) ABSTRACT

A note taking application displays a notebook with a multi-column hierarchical navigation display. Each column has navigation elements that are activated to navigate through one or more notebooks. The user can control the display to expose more or fewer navigation columns.

The present application is based on and claims the benefit of U.S. provisional patent application Ser. No. 61/537,938, filed Sep. 22, 2011, the content of which is hereby incorporated by reference in its entirety.

### BACKGROUND

### Background

There are a wide variety of different knowledge bases that are currently in use. One type of knowledge base is a notebook system that supports note taking applications. In such a system, it is not uncommon for there to be multiple different notebooks, each of which are arranged in a generally hierarchical fashion. Each notebook can have multiple different sections or chapters, and each section can have multiple different pages. Each page can have multiple different documents located thereon or embedded therein.

For instance, in one notebook system, a notebook may be created that corresponds to a given subject in school. The notebook can have different tabs associated with different sections, and those sections may include, for instance, a section devoted to chapter notes for the subject, a section devoted to a lab for the subject, a section devoted to study group meetings that are to be scheduled or that have been scheduled regarding the subject, a home section or home page that generally describes the subject, etc.

Each of the sections may contain a plurality of different pages, and each page can contain one or more documents. With respect to the present discussion, the term document means a collection of content. For instance, a document may be a word processing document or a page in the document, or it may be a spreadsheet or even a page in the spreadsheet, a video or audio file, a slide presentation or individual slides in the presentation, a set of drawings in a drawing document or the individual drawings, notes entered on a page using free form text entry, or any other similar type of content collection.

It can be difficult to lay out the information in such a system so that it is easy to use. Many current layouts are quite cumbersome, and it is difficult to navigate through one or more notebooks.

The discussion above is merely provided for general background information and is not intended to be used as an aid in determining the scope of the claimed subject matter.

### SUMMARY

A note taking application displays a notebook with a multi-column hierarchical navigation display. Each column has navigation elements that are activated to navigate through one or more notebooks. The user can control the display to expose more or fewer navigation columns.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative embodiment of a knowledge base system that includes a note taking application.

FIGS. 1A and 1B are flow diagrams illustrating one embodiment of the operation for the system shown in FIG. 1.

FIG. 2 illustrates navigation among a plurality of different views.

FIGS. 3-22 show examples of user interface displays that can be generated.

FIGS. 22A-22B are a flow diagram showing creation of new content.

FIGS. 23 and 24 are illustrative user interface displays.

FIG. 25 shows one embodiment of a cloud computing environment.

FIGS. 26-28A show embodiments of mobile devices.

FIG. 29 shows one embodiment of an illustrative computing environment.

### DETAILED DESCRIPTION

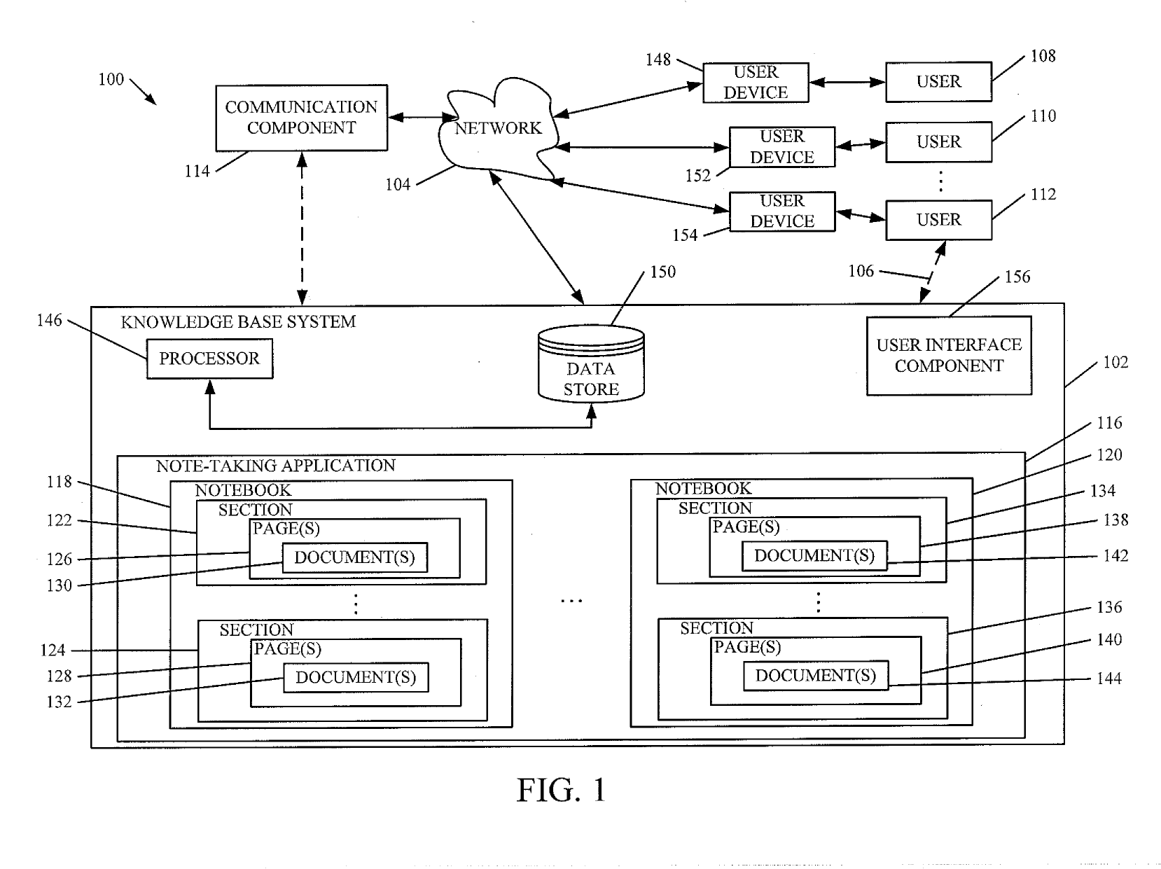

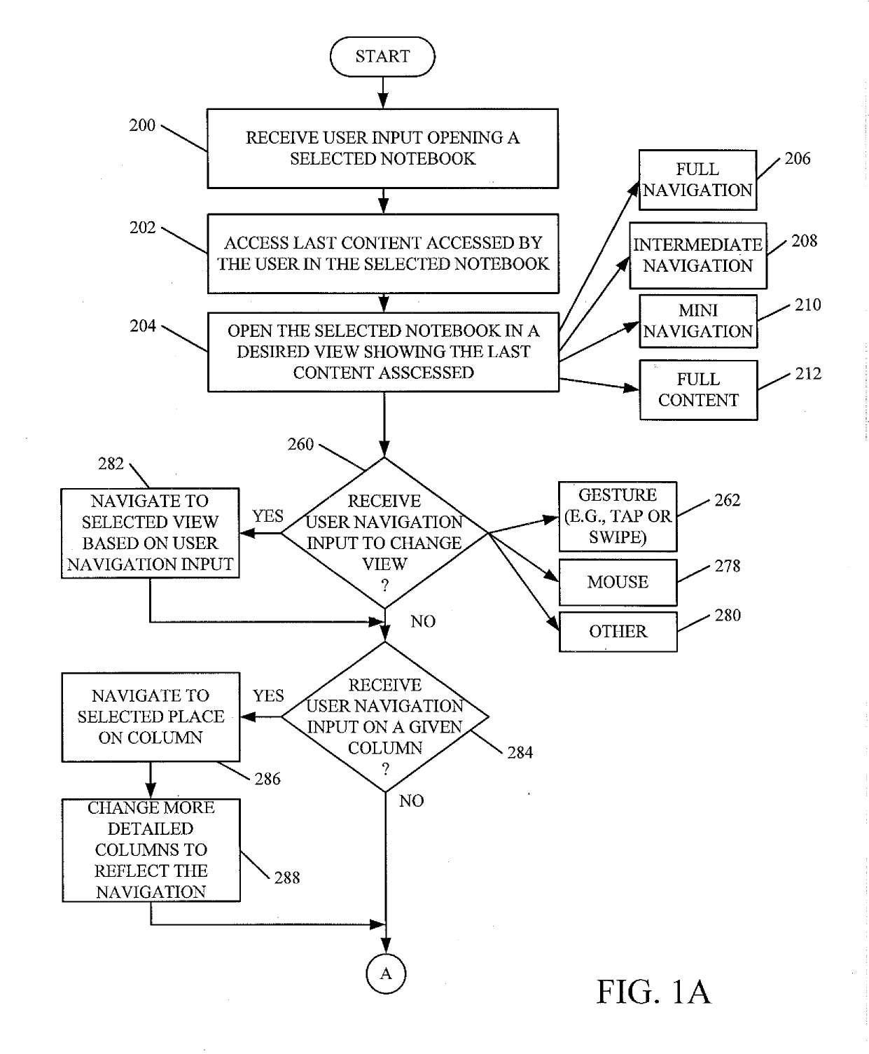

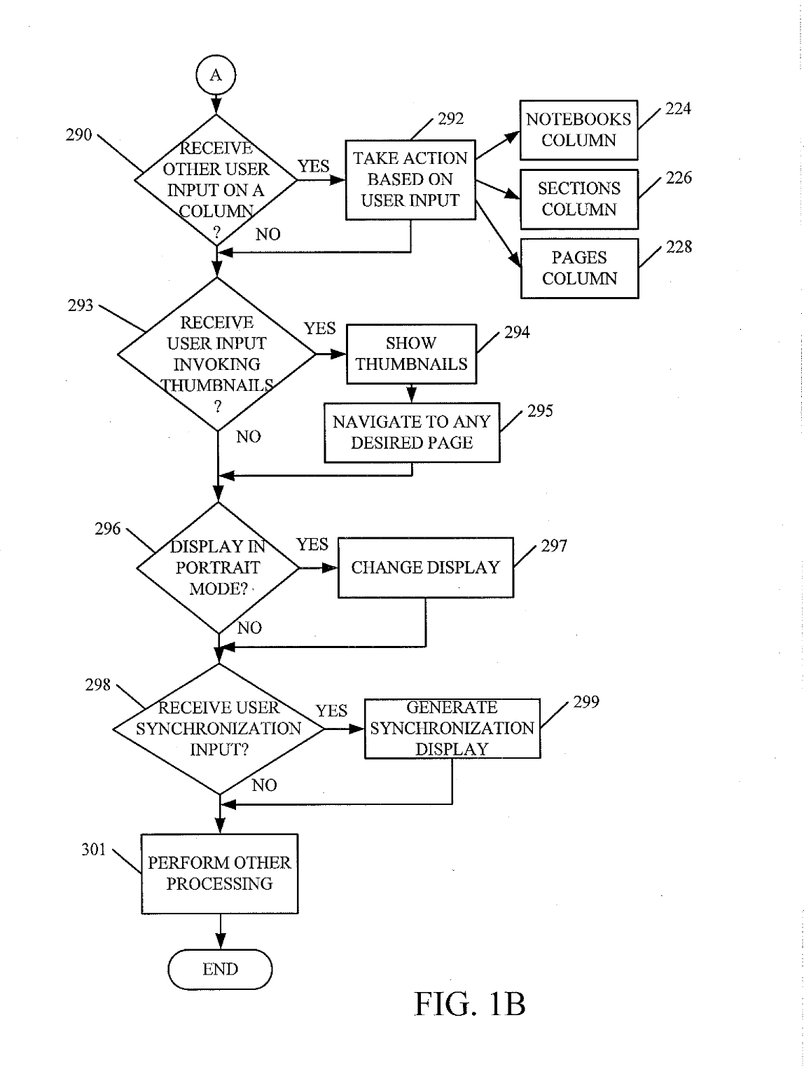

FIG. 1 is a block diagram of a collaboration system 100. Collaboration system 100 shows a knowledge base system 102 connected either through network 104 or directly (as indicated by dashed arrow 106) to a plurality of users 108, 110 and 112 that generate or collaborate on collections of documents in knowledge base system 102 through user devices 148, 152 and 154. FIG. 1 also shows that users 108-110 can be connected with one another and with knowledge base system 102 through a communication component 114.

In the embodiment shown in FIG. 1, knowledge base system 102 illustratively supports a note taking application 116 that, itself, supports a plurality of notebooks 118-120. Each notebook illustratively includes a hierarchical arrangement of content. In the embodiment shown in FIG. 1, notebook 118, for instance, includes a plurality of sections 122 and 124. Each section illustratively has a plurality of pages 126 and 128 and each of the pages illustratively includes one or more documents 130 and 132. Also, by way of example, notebook 120 illustratively includes sections 134 and 136, each of which includes one or more pages 138 and 140, each page including one or more documents 142 and 144. For the sake of the present discussion, as mentioned above, the term documents not only includes text entered on a page but word processing document files, and other collections of content. For instance, the term document includes video clips, audio clips, individual pages in the notebook, slideshow presentations, spreadsheets, drawings in a drawing program and other collections of content.

Knowledge base system 102 also illustratively includes a processor 146 which can be a computer processor with associated timing circuitry and memory (not shown). Processor 146 is operably coupled to, and activated by, other components in system 100 to facilitate their function. Knowledge base system 102 also illustratively includes a data store 150, and user interface component 156. Data store 150 can be used to store notebook system 116, or parts of it, and user interface component 156 is used to generate user interface displays for users 108-112, along with user-input mechanisms that receive user inputs for operating knowledge base system 102 and note taking application 116. Any or all of these components can be part of note taking application 116, although they are shown separately.

The detailed operation of system 102 is described below. Briefly, however, the plurality of users 108-112 can access, through system 102, one of notebooks 118 and 120. Users 108-112 can illustratively edit or collaborate on the notebook by editing pages or documents in the various notebooks in note taking application 116.

In one embodiment, each user 108-112 can illustratively operate a separate note taking application 116 by way of interactions with their devices. The devices, 148, 152 and 154 shown in FIG. 1 may be any of a wide variety of computing devices including, but not limited to, laptop computers, personal digital assistants, mobile phones, tablet computers, personal computers, e-reader devices, multi-touch input/output panels, etc. When the users 108-112 utilize one of their computing devices 148, 152, 154 to interact with the note taking application 116, part of this interaction illustratively involves storage and retrieval of application content relative to a “cloud-based” server. Those skilled in the art will appreciate that this signifies that the content is stored on a network server remotely accessed by any or all of devices 148, 152 and 154 in accordance with user-initiated commands.

In one embodiment, the note taking application 116 includes application components that run at least partially from the devices 148, 152 and 154. However, the application can also be partially, primarily or completely operable from a network location, for example, from within a cloud. In this case, devices 148, 152 and 154 may include a separate application such as a network browser application for facilitating interaction with the note taking application 116. Any combination of remote or client-based distribution of functions or components of the note taking application 116 should be considered within the present scope.

Regardless of the particular distribution of the note taking application functionality, it is consistent with one embodiment for a collection of content data in notebook 118-120 to be stored within data store 150. The note taking application 116 is illustratively a free-form information gathering and multi-user collaboration platform that enables the users 108-112 to store notes, drawings, screen clippings, audio, video and any other item of content or document as part of notebooks 118-120. Access to the content can be shared among the users based on certain preferences and system settings. When one or more of users 108-112 wishes to share all or parts of a notebook 118-120 with other of the users, functions are included within the note taking application 116 to facilitate this.

In one embodiment, the note taking application 116 differs from a traditional word processor at least in that it is much more free-form in terms of how and where the user is able to submit content into the application user interface for storage as part of notebooks 118-120. Further, in one embodiment, users of the note taking application 116 generally are not required to issue a save order or command because the note taking application 116 automatically saves the data as part of the notebook as it is entered. Still further, in one embodiment, information entered into the note taking application 116 is organizable into an electronic version of one or more notebooks 118-120, as shown in FIG. 1.

As has been described, the note taking application 116 supports a multi-user environment wherein the content collections may be shared. In one embodiment, the application allows off-line editing and later synchronization. In another embodiment, the application allows collaboration in that more than one person can work on “the same page” at the same time. These are but examples of features of an illustrative note taking application 116. The scope of the present system is not limited to a system that includes an exact combination and configuration of features as described. Other configurations and features should also be considered within the scope. For example, while the architecture shown in FIG. 1 shows only one data store 150, those skilled in the art will appreciate that there can actually be many databases distributed in a very complex configuration.

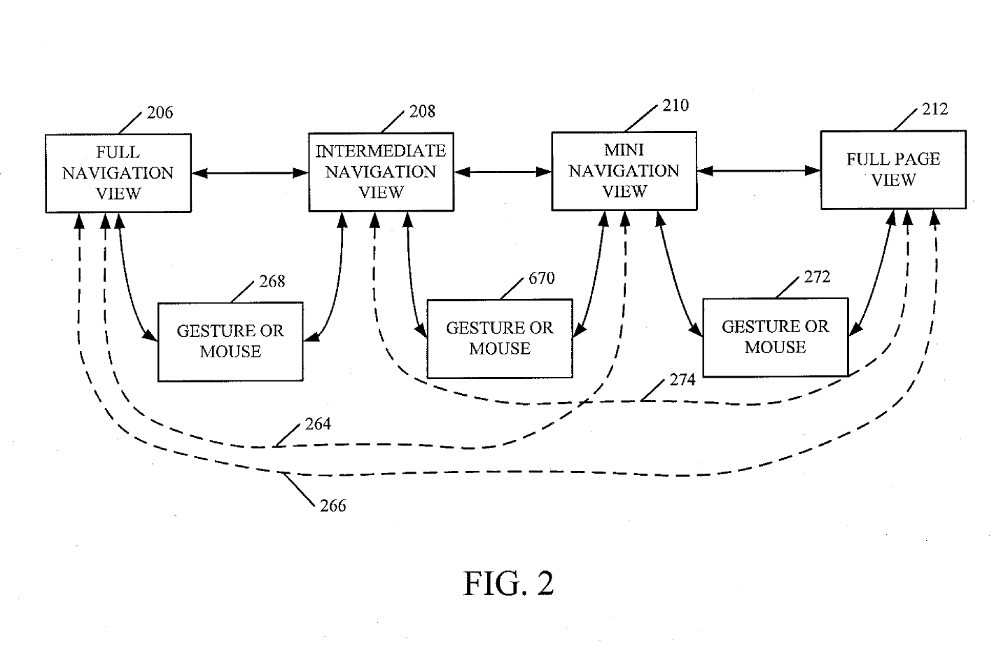

FIGS. 1A and 1B show one embodiment of a flow diagram illustrating some aspects of the operation of the system 100 shown in FIG. 1. In one embodiment, one of users 108-112 (such as user 108) provides a user input through user input device 148 requesting knowledge base, and specifically note taking application 116, to open a selected notebook (such as notebook 118). This is indicated by block 200 in FIG. 2. In one embodiment, the user simply opens a browser or another user interface and provides a suitable input that causes processor 146 to launch note taking application 116, and the user then operates note taking application 116 to open notebook 118.

Once notebook 118 is opened, note taking application 116 accesses data store 150 to identify the content last accessed by user 108 in the selected notebook (notebook 118). This is indicated by block 202 in FIG. 1A.

Note taking application 116 then opens notebook 118 in a desired view, showing the last content that was accessed by user 108. For instance, if user 108 was in a specific section and on a specific page of notebook 118 when user 108 last accessed notebook 118, then note taking application 116 opens notebook 118 to that same page, in a desired view. This is indicated by block 204 in FIG. 1A.

In accordance with one embodiment, there are a variety of different views within which note taking application 116 can display notebook 118 to user 108. FIG. 1A shows that the views include a full navigation view 206, an intermediate navigation view 208, a mini navigation view 210, and a full content view 212. These views are also shown in FIG. 2. FIG. 2 also illustrates that the user can navigate among the views by using either a touch gesture (on a touch-sensitive screen) or a more conventional input, such as using a point and click command with a mouse or other pointing device. Before describing navigation among the various views, however, some illustrative examples of the views will first be described.

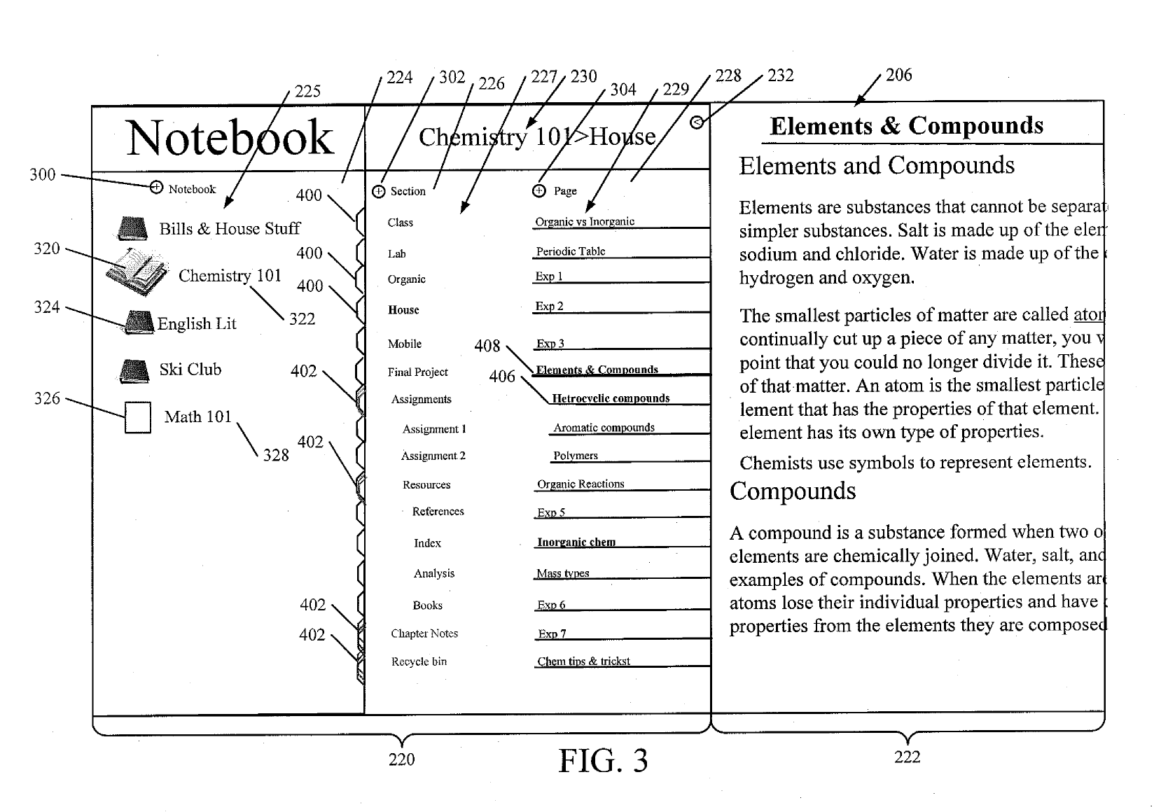

FIG. 3 shows one embodiment of a user interface display showing full navigation view 206 for notebook 118. In the embodiment shown in FIG. 3, notebook 118 is entitled “Chemistry 101”. The full navigation view 206 includes two portions. The first portion is the navigation display portion 220 and the second portion is the content display portion 222.

Navigation display portion 220 includes a plurality of columns. The columns include notebook column 224, section column 226 and page column 228. Notebook column 224 shows a list of actuable notebook navigation elements 225. Each notebook navigation element 225 corresponds to a notebook 118-120 in application 116. Section column 226 displays a list of section navigation elements 227, each corresponding to a section for the selected notebook in column 224. The section column 226 can also include section groups (which are sections with subsections within them). Page column 228 shows a list of page navigation elements 229, each corresponding to a page of the selected section in section column 226. Page 228 can include multiple levels of subpages as well. Therefore, since the user has selected the Chemistry 101 notebook in column 224, the sections corresponding to the section navigation elements 227 in section column 226 are the sections of the Chemistry 101 notebook. It can be seen that the user has also selected the “House” section from column 226. Therefore, the pages corresponding to the page navigation elements 229 in page column 228 are the pages in the “House” section of the “Chemistry 101” notebook.

It can thus be seen that the navigation elements in columns 224, 226 and 228 are hierarchical. The navigation elements displayed in column 226 depend on the selected navigation element in column 224. Similarly the navigation elements displayed in column 228 depend on the selected navigation element in column 226, and the content portion 222 is dependent on the selected navigation element in column 228.

As briefly mentioned above, when note taking application 116 opens the Chemistry 101 notebook for the user, it will open the notebook to display the content last accessed by the user. Therefore, note taking application 116 has opened the Chemistry 101 notebook to the “House” section and has also opened it to the “Elements and Compounds” page. The content display portion 222 is displaying the “Elements and Compounds” page in the “House” section of the “Chemistry 101” notebook, because this is the last page of content that was accessed by user 108 in this notebook.

It can also be seen that, in full navigation view 206, a header portion 230 is displayed above the section and page columns. In one embodiment, the header portion 230 shows the notebook that has been opened and the section to which it has been opened. When the user selects a page in page column 228, header 230 can also, optionally, show the specific page selected by the user.

In one embodiment each section navigation element in column 226 has a corresponding tab 400 or 402. Each of the tabs has a different color. Thus, as the user switches between various sections in column 226, the color of the header box of header portion 230 changes to match the color of the tab corresponding to the section selected by the user. Thus, the header 230 is dynamic. Of course, other types of header displays could be used as well.

Full navigation view 206 also illustratively includes a navigation user input element 232. In the embodiment shown in FIG. 3, element 232 is a chevron which, when clicked on by the user using a point and click device, or when tapped by the user using a gesture on a touch sensitive screen, or when activated using a keyboard, a voice command or otherwise, causes note taking application 116 to navigate to views 208, 210 and 212 shown in FIG. 2. Of course, there are other ways of performing user input functionality, such as using specific keys on a keyboard, as well. Before describing more features of the individual columns 224, 226, 228 and content portion 222, the other views 208, 210 and 212 will be discussed briefly.

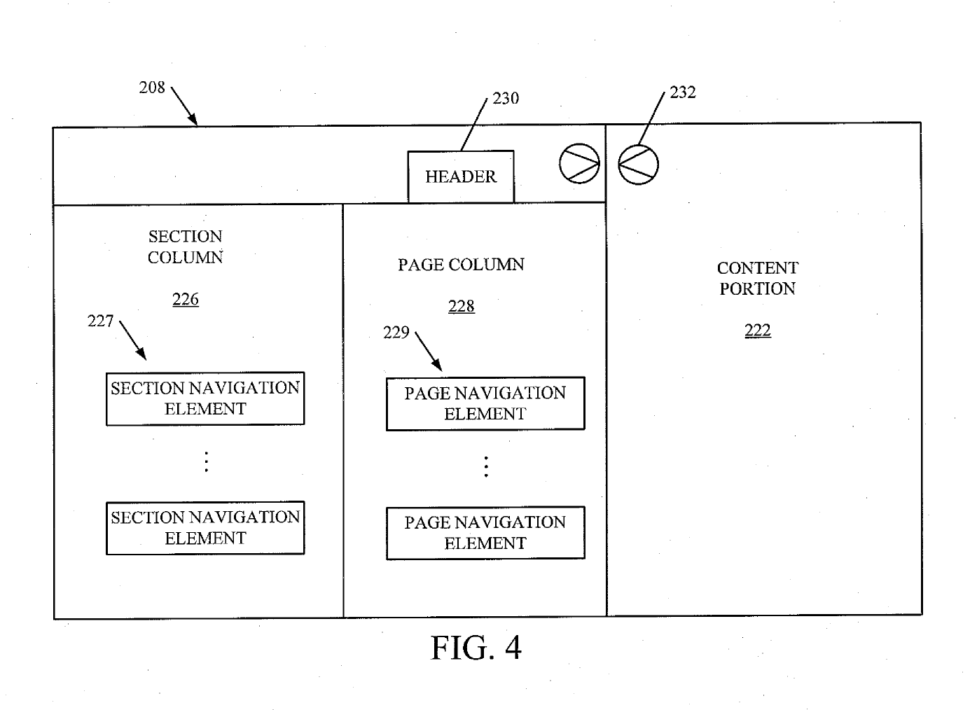

FIG. 4 is a user interface display showing intermediate navigation view 208. A number of the items shown in display 208 are similar to those shown in display 206 in FIG. 3, and are similarly numbered. However, it can be seen that the intermediate navigation view 208 does not show the notebook column 224. Instead, it only shows the section column 226, the page column 228, and a larger view of content portion 222. In one embodiment, when notebook 118 is being displayed in the intermediate navigation view 208, the content in portion 222 is editable by the user. In another embodiment, it may not be editable, and this can be set, as desired.

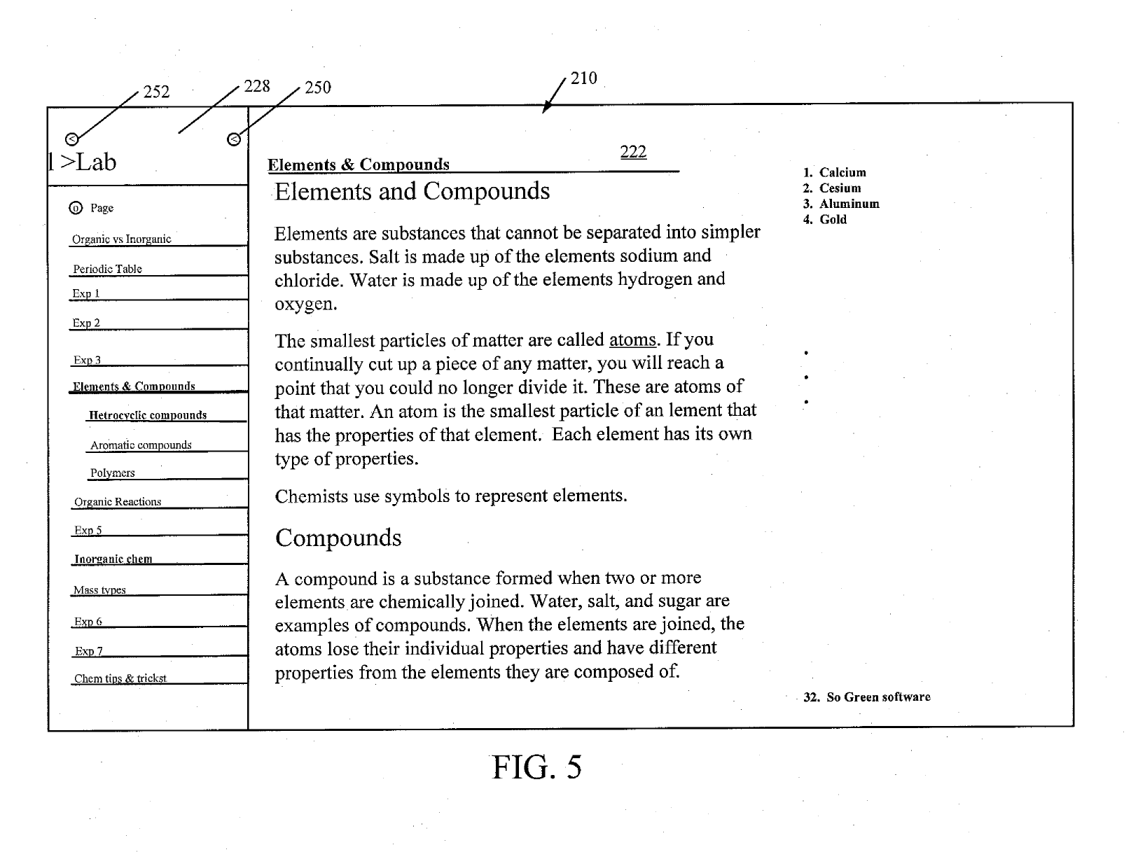

FIG. 5 shows a user display that is generated illustrating the mini navigation view 210. Again, some of items in view 210 are similar to those shown views 206 and 208, and are similarly numbered. However, in the mini navigation view 210, it can be seen that only the content portion 222 is displayed along with the page column 228. Mini navigation view 210 allows the user to easily capture and read content on content portion 222, yet still navigate, quickly and efficiently, to other pages in the section that is currently being displayed. It can also be seen that, because the content portion 222 has been shifted to the left on the display, items on the right of the content page can be seen, even though they were not initially seen in the other views, when more of the navigation UI was displayed. Page column 228 is vertically pannable so that the user can easily scroll through the various pages in the section, and select different pages for viewing in content portion 222. As the user selects a different page, the content of that page is displayed in content portion 222.

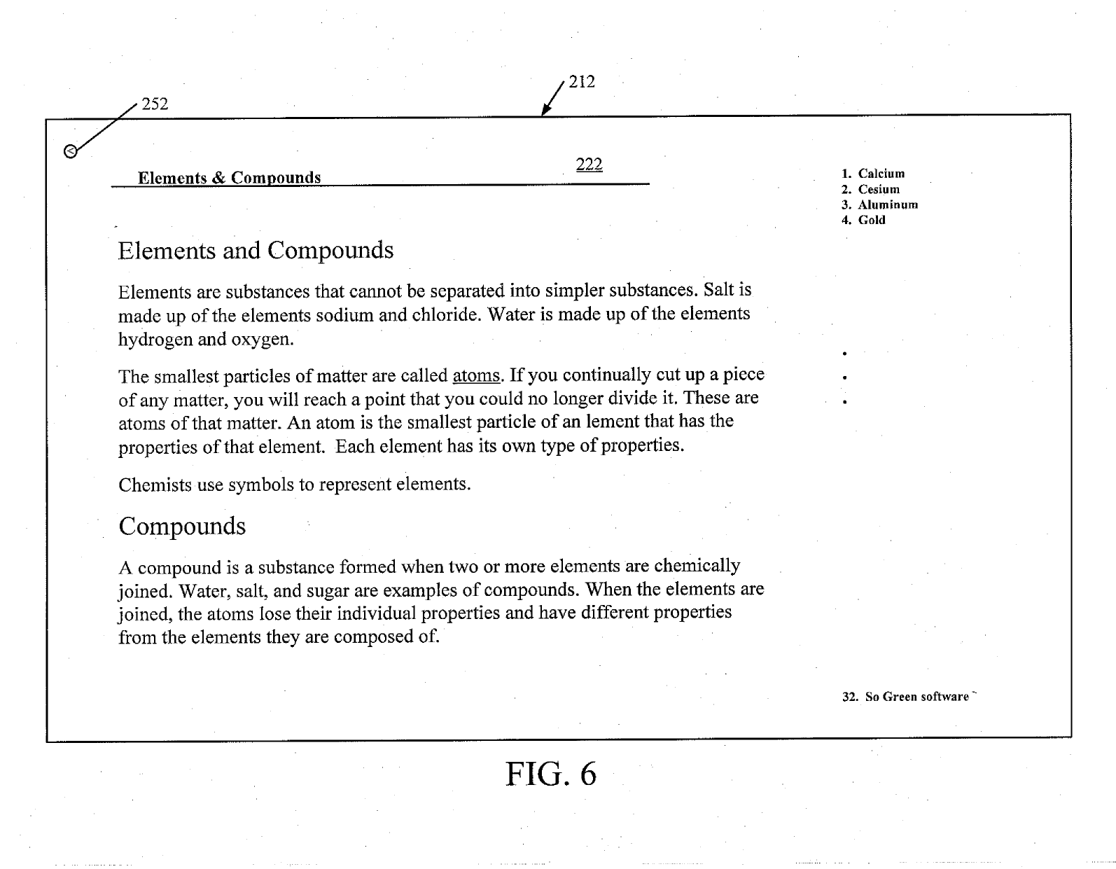

It can also be seen that display 210 includes two navigation elements 250 and 252. Navigation element 252 can be used to navigate back to the intermediate navigation view 208 shown in FIG. 4 and to the full navigation view 206. Navigation element 250 allows the user to navigate to the full page view 212 shown in FIG. 6.

FIG. 6 shows a user interface display that is generated to illustrate the full page view 212. In full page view 212, the content in content portion 222 is fully editable by the user. View 212 is provided with navigation element 252, which allows the user to navigate backward to the mini navigation view 210, the intermediate navigation view 208 and the full navigation view 206.

Referring again to FIG. 1A, once the notebook 118 has been opened and the desired view has been displayed, the user can navigate to other views. Receiving a user navigation input to change views is indicated by block 260 in FIG. 1A. The user navigation inputs can assume a number of different forms.

The user can shift views using a point and click device, such as mouse. In that case, the user simply points and clicks on the navigation elements 232, 250 and 252, in order to change views. This is indicated by blocks 268, 270 and 272 in FIG. 2. Of course, the user can navigate in the opposite direction as well.

In addition, the user can navigate among the views using touch gestures. Assuming that the user is in the full navigation view 206 shown in FIG. 3, and assuming the display device is a touch sensitive screen, then the user can use touch gestures 262 to navigate to different views. By way of example, the user can tap on elements 232, 250 or 252 to move by one view in FIG. 2. The user can tab multiple times to move by more than one view in FIG. 2. For example, if the user is in view 206 and taps twice, the view can be changed to view 210.

The user can use other touch gestures to navigate as well. For instance, if the user touches full navigation view 206 and swipes to the left, this can cause application 116, using user interface component 156, to change the view from the full navigation view 206 to the intermediate navigation view 208. Of course, if the user makes a larger or quicker touch gesture, this can cause user interface component 156 to shift from the full navigation view 206 to the mini navigation view 210, or even to the full page view 212. Shifting among views in this way is indicated by arrows 264, 266 and 274 in FIG. 2. Using a touch gesture in order to navigate among views is indicated by block 262 in FIG. 1A, using a point and click device (such as a mouse) is indicated by block 278, and using some other type of gesture or user input mechanism is indicated by block 280 in FIG. 1A.

Once note taking application 116 has received the user navigation input, then it navigates to the desired view and user interface component 156 displays the desired view to the user, based on the user's navigation input. This is indicated by block 282 in FIG. 1A.

Therefore, it can be seen that notebook 118 is displayed so that a gesture to the right or to the left can be done in order to move between different sets of content. In one embodiment, the display is hierarchal from the left to the right. That is, the content on the left side of the display is more general in nature while the content on the right is more detailed in nature. Therefore, if the user causes the display to move from the right to the left, that causes more detailed information to be displayed on the right side of the display. On the other hand, if the user moves the display from the left to the right, that exposes more general content on the left side of the display. In addition, the more detailed content is related to the more general content. For example, the detailed content on the content portion 222 of display 206 is content that is specific to the selected page in page column 208. The selected page is specific to the section chosen in section column 226, and the chosen section is specific to the notebook selected in column 224. Thus, all of the content on the display is related, and it progresses from general content on the left to detailed content on the right. The direction can change. For instance, when the user's language reads from right to left (such as Arabic and Hebrew) the layout is reversed with general content on the right and detailed content on the left. Similarly, when the language is read from top to bottom (as in some Eastern languages), the “columns” are arranged vertically on the screen with more general content on the top and more detailed content on the bottom. Thus, when the present description refers to content being arranged in a given direction, it is because the user's language is read in that direction. If the language is read in a different direction, the content is arranged in that way. This provides an intuitive and hierarchical layout of information in each notebook.

It should also be noted that all of the navigation elements in navigation portion 222 can be hidden so that only the content in content portion 222 is displayed. However, the navigation elements can quickly and easily be accessed by a single swipe gesture or other user input. Thus, the content need not be cluttered with the navigation features on a given display, but those features can still be quickly and easily accessed by the user.

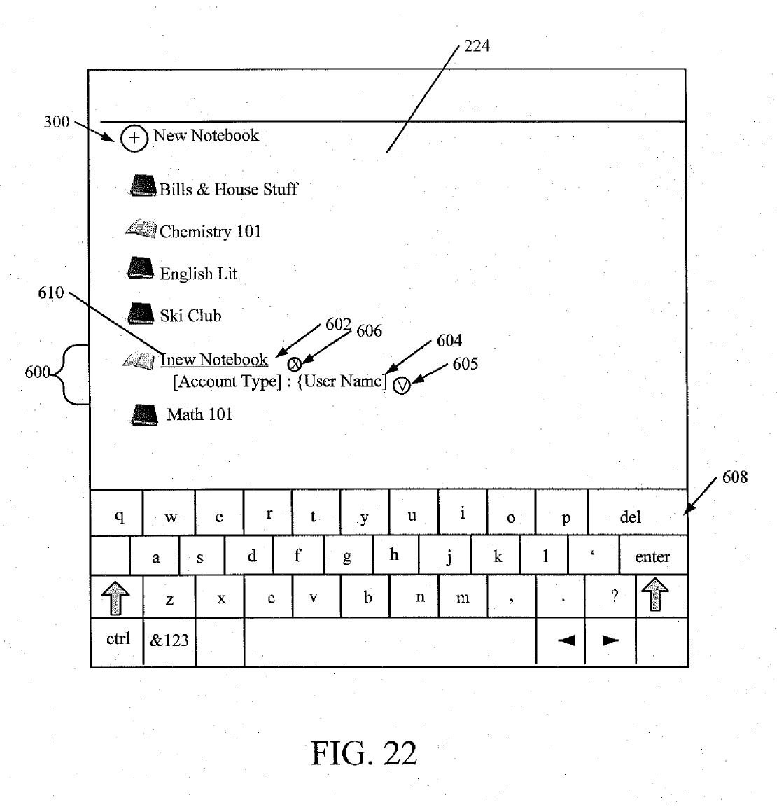

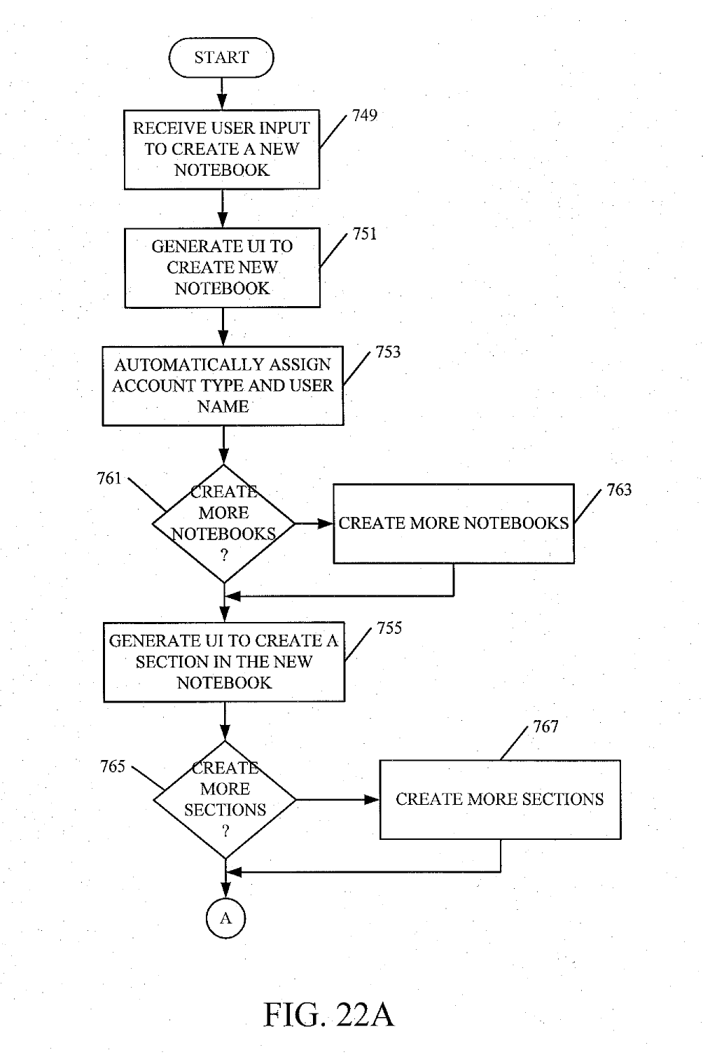

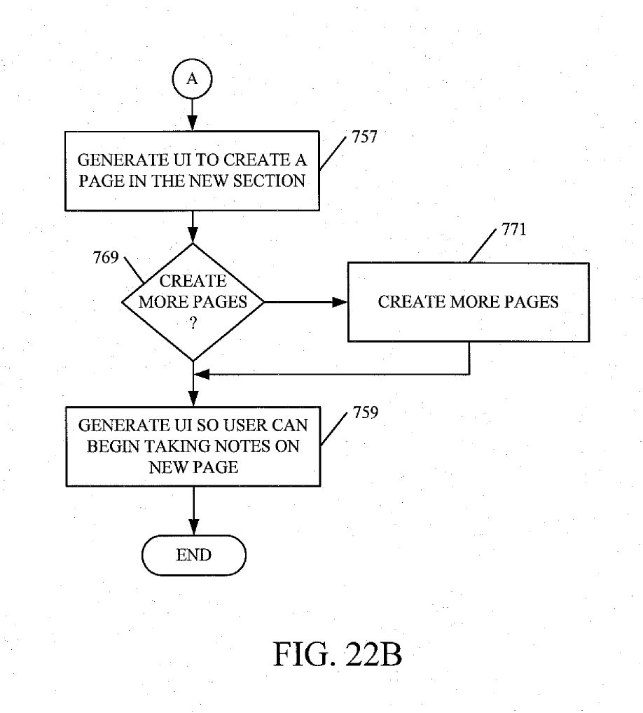

Having now described each of the views 206-212, each of the individual columns 224-228, and content portion 222 will now be described in more detail. It can first be seen that each of columns 224, 226 and 228 have, as an entry point in each column, a mechanism for creating additional content. Notebook column 224 includes a notebook creating user input mechanism 300 which, when actuated by the user, enables the user to input information necessary to create a new notebook. Section column 226 includes a section creation user input mechanism 302. When actuated by the user, mechanism 302 causes a display to be generated so that the user can input information necessary to create a new section in the selected (or newly created) notebook from column 224. Similarly, page column 228 includes a new page user input mechanism 304. When actuated by the user, mechanism 304 allows the user to input information to create a new page in the section selected in column 226. Specific examples of how a new notebook, section and page can be created is discussed in greater detail with respect to FIGS. 22-24 below. It should be noted, however, that in one embodiment, creation of these new elements is from the general user interface displayed for a given notebook 118. The user does not need to navigate to a special “creation” interface, but can initiate the creation of new content from the general views discussed.

In one embodiment, each of the columns 224, 226 and 228 are vertically pannable, independently of the other columns in the navigation portion 220. Therefore, the user can easily pan through column 226 to view various sections in the selected notebook from column 224, without changing the pages in column 228 or the content in portion 222. However, though the columns are independently pannable, when the user selects a different navigation element in a given column, then the content in the columns showing dependent information (e.g., the columns to the right) are all updated to reflect that change.

Therefore, in one embodiment, the note taking application 116 receives a user navigation input (the user actuates a different navigation element) in a given column. This is indicated by block 284 in FIG. 1A. In that case, the note taking application 116 navigates the user to the place in the selected notebook represented by the selected navigation element. This is indicated by block 286 in FIG. 1A. Once the user has selected a new navigation element in a given column, then the more detailed columns to the right of that column are changed to reflect the navigation. This is indicated by block 288 in FIG. 1A.

By way of example, and again referring to FIG. 3, assume that the user has panned the section list and selected a different section navigation element in the section list in column 226. In that case, the pages displayed in columns 228 are updated to display the pages in the newly selected section from column 226. Similarly, the content in content portion 222 is updated to reflect the content on the page last accessed by the user in the newly selected section. Of course, if the user had not accessed any pages in that section, then the page displayed in content portion 222 will illustratively be the first page of the selected section. In addition, header 230 in FIG. 3 is updated so the new section and, optionally, the selected page (if any) is now identified in header portion 230.

FIG. 1B shows that application 116 can receive other user inputs on a specific column. This is indicated by block 290 in FIG. 1B. In response, application 116 takes the appropriate action based on the user inputs. This is indicated by block 292. Various actions can be taken on the notebook column 224, on the section column 226 and on the pages column 228. A number of those user inputs actions will now be described with reference to FIG. 3.

The notebook column 224 will now be described in more detail. In one embodiment, the notebook column 224 includes a list of notebook navigation elements 224, each representing a notebook that is contained in note taking application 116. The list of notebooks illustratively includes an icon and a textual description of the notebook. For instance, the “Chemistry 101” notebook includes an icon 320 that shows an open notebook. The textual portion 322 textually describes or titles the notebook. The icon 320 illustratively reflects the status of the corresponding notebook. If the notebook is open in application 116, and has been selected by the user, then icon 320 illustratively indicates this. In the embodiment shown in FIG. 3, icon 320 shows an open notebook icon.

However, if the notebook is open in application 116 but has not been selected by the user, then the icon reflects this as well. For instance, the icon 324 corresponding to the “English Lit” notebook shows a bold representation of a notebook, but the notebook icon 324 is not displayed in the open fashion, as is icon 320. Of course, where the display is a colored display, then the open but unselected notebook can be displayed in a given color as well. If the user selects an open, unselected notebook (such as by tapping on the “English Lit” notebook navigation element) then application 116 navigates to that notebook and makes it the selected notebook. Accordingly, all of the content in the columns to the right of the notebook column 224 are updated accordingly.

Alternatively, if one of the notebooks has neither been selected nor opened, but is instead a closed notebook in application 116, the icon and textual representation show this as well. For instance, the “Math 101” notebook has an icon 326 and a textual representation 328. In one embodiment, the Math 101 notebook is closed. Thus, the icon and text color are both grayed out. If the user selects the navigation element (such as by tapping on the icon or text) application 116 navigates the user to this notebook, downloads the notebook to a local cache (such as to data store 150) and navigates to it and then begins the synchronization process, which is described in greater detail below.

In another embodiment, closed notebooks are represented differently. Instead of appearing in the list below the open notebooks, the most recently closed N notebooks (such as the last 10 closed notebooks) appear in a “Closed Notebooks” bucket at the bottom of the notebooks column with a downward pointing chevron. Tapping on the chevron expands the list and tapping on any of the closed notebooks in the list opens the notebook and moves it into the portion of the column showing open notebooks.

Sections column 226 is now described in more detail. Sections columns 226 is also vertically pannable, independently of the other navigation columns. The sections navigation elements are illustratively ordered in section column 206 based upon creation time, but they can be ordered in other ways or reordered by the user as well. The sections can be grouped together. When this is done, the section navigation elements in a group are made dependent children of a parent element. The indented section display elements are dependent on the outdented navigation element immediately above them. Section groups are illustratively displayed below the sections in section column 226, in alphabetical order. For instance, with reference to FIG. 3, section groups include “assignments” and “chapter notes”.

Each of the section navigation elements in section column 226 illustratively has a tab 400 associated with it. The tab 400 for the selected section is illustratively displayed in a different color from the tabs for the other sections. In addition, in one embodiment, the section name is also displayed in a distinct color, different from the other names of sections in column 226.

By way of example, it can be seen that the user has selected the “House” section in column 226. The tab 400 associated with the “House” section, as well as the letters in the “House” section are illustratively displayed in a distinctive way, which visually distinguishes it from the other sections in column 226.

The unselected section navigation elements in column 226 also illustratively have tabs with corresponding colors. When the user taps on the section navigation element, application 116 navigates the user to that section. This makes that section the newly selected section.

Section groups illustratively have tabs 402 which are different than tabs 400 for the other sections. In one embodiment, the tabs 402 give the visual representation of a plurality of items stacked on top of one another. This indicates that a tab 402 corresponds to a section group.

In one embodiment, the section groups can be shown in collapsed form. For instance, the “chapter notes” section group in column 226 is shown in collapsed form. However, the “assignments” section group and the “resources” section group are shown in expanded form. When the user taps on a collapsed section group navigation element (e.g., a section group name), this causes the application 116 to navigate to the last section that the user visited in the section group, but does not expand the group. If the user taps on the chevron next to a section group's name, application 116 expands the section group and navigates to the last section in the group that the user visited. Therefore, by way of example, if the “assignments” section group were collapsed and the user tapped on it, application 116 would navigate the user to the “assignments” section group and specifically to the section within that group that was last visited by the user. If the user taps on a different section in that section group, application 116 navigates the user to that new section.

In addition, there can be section groups within sections groups. The furthest dependent section groups can optionally be displayed in a manner that shows this (such as by being smaller than the top level section group), and their names are indented beneath their parent. By way of example, it can be seen that the “resources” section group is a section group within another section group (the “assignments” section group). It can also be seen that the sections within the “resources” group are indented relative to the parent.

Pages column 228 will now be described in more detail. In one embodiment, pages column 228 is vertically pannable, independently of the other navigation columns. Page names can have lines beneath them, but they need not. The page names (and optionally the line beneath the page names) are displayed in the same color as the selected section color from section column 226. Also, in one embodiment, subpages are shown indented from a parent page. For instance, subpage 406 is the “heterocyclic compounds” page which is a subpage of the “Elements and Compounds” page 408 in the list of page navigation elements 229. It can be seen that subpage 406 is indented relative to page 408. Similarly, in order to provide an additional visual cue, the underline under subpage 406 (where it is included) is also indented to the same indent level as the textual description of page 406. It should also be noted that, in one embodiment, application 116 supports multiple levels of subpages (e.g., two levels or more), while only one level of subpage is shown in FIG. 3.

Another user input action that can be taken on a given column is to reorder items in that column. Tapping on a navigation element is used to navigate to that element and can also be used to indicate that the element is movable (such as draggable) on the user interface display. Placing a navigation element into the drag and drop mode can be used to reorder the element within a single column.

For instance, when the user places a specific page navigation element on page column 226 into the drag and drop mode, and drags it to another position in the column, then the page is reordered as desired. Similarly, the user can reorder notebooks in the notebook column 224 and sections in the section column 226 in the same way. Of course, the user can also reorder sections within their section groups in section column 226 and can reorder subpages relative to a parent page in the page column 226.

Similarly, however, the user can promote a subpage into a page or demote a page into a subpage. The user simply places the page navigation element into drag and drop mode and changes its indent level by moving it to a desired location on the column. In addition, the user can move sections in and out of section groups in the same notebook as well. It should also be mentioned that this and other functionality can optionally be accessed through a secondary menu, such as the radial menu described below.

In addition, it should be noted, in one embodiment, drag and drop functionality can be used to organize elements across columns. For instance, if the user places the “House” section navigation element from column 226 into the drag and drop mode and drags it underneath another notebook in notebook column 224 (such as under the “English Lit” notebook), then the “House” section can be moved to the other notebook (such as from the “Chemistry 101” notebook to the “English Lit” notebook, for instance).

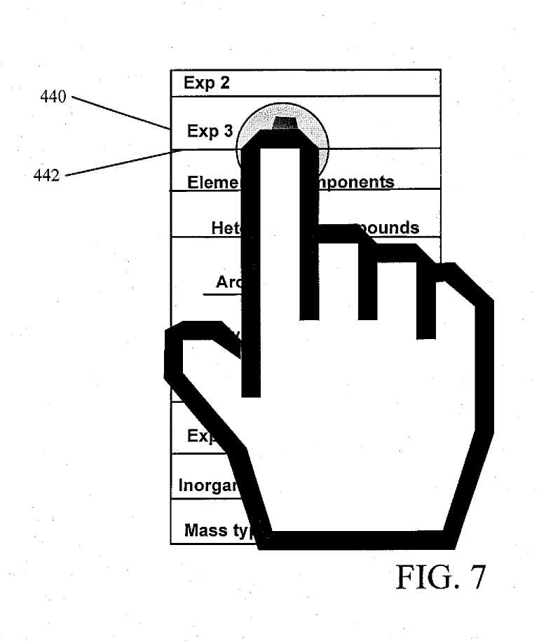

FIGS. 7-13 show various user interface displays illustrating different drag and drop functionality. FIG. 7 shows that the user has placed the “Exp3” page navigation element 440 from pages column 228 into the drag and drop mode by tapping on it, and then has placed his or her finger on it as well. As the user drags and drops element 440 to a target location on the user interface, the line 442 below element 440 illustratively represents the placement in a given list and the indentation level at the target location.

In one embodiment, the item being dragged and dropped will be represented on the display by a live preview of the actual item, and not just represented by a general visual representation of it. As the item is dragged into a desired position between other existing items on the display, the existing items separate to expose a space for the dragged item to be dropped

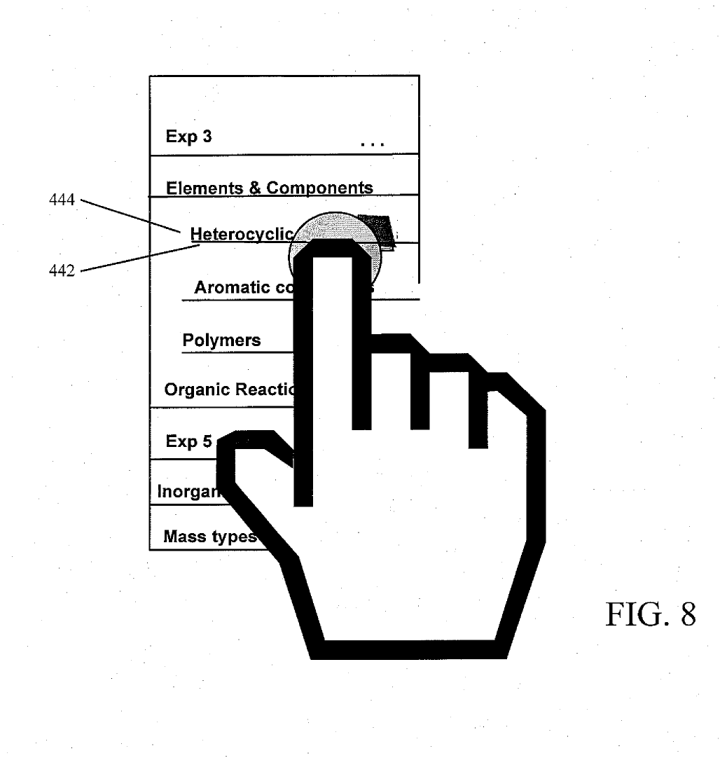

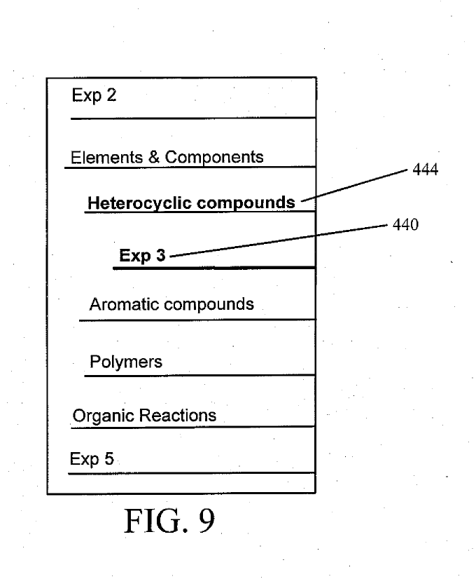

FIG. 8 shows that the user has now dragged element 440 to a location under the “Heterocyclic Compounds” subpage navigation element 444. Because the line 442 is at an indentation level relative to navigation element 444, this means that the “Exp3” page will now be a subpage of the “Heterocyclic Compounds” page. Of course, if the user wants to make the “Exp3” a full page relative to the Heterocyclic Compounds page, then the user simply slides his or her finger to the left so that the line 442 is at the same indentation level as navigation element 444. In order to commit the reorder action, the user lifts his or her finger form the draggable item when it is positioned in the desired target location and indentation location level. FIG. 9 shows a user interface display which indicates that the Exp3 page navigation element 440 is now located in indented location relative to the Heterocyclic Compounds page navigation element 444.

In one embodiment, if the user attempts to drag an element across a boundary where it is not draggable, this is indicated by a visual cue. In the embodiment discussed herein, the underline beneath the navigation element disappears to indicate to the user that the element cannot be dropped in the present location.

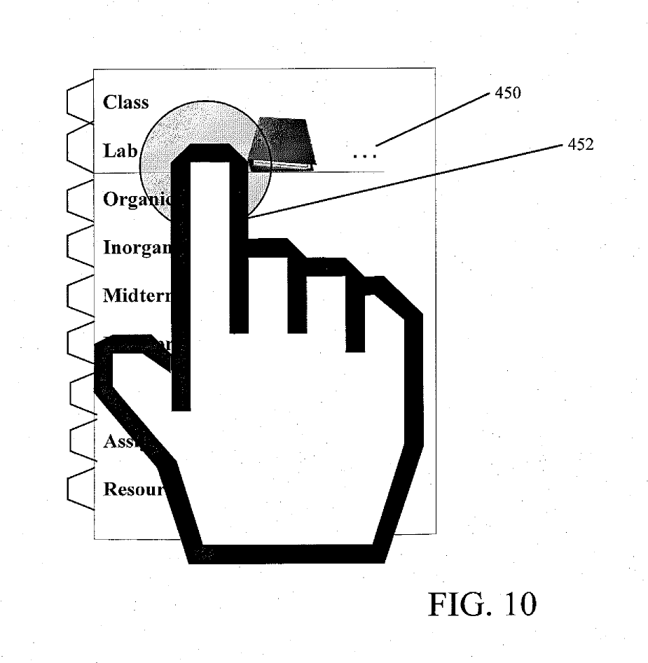

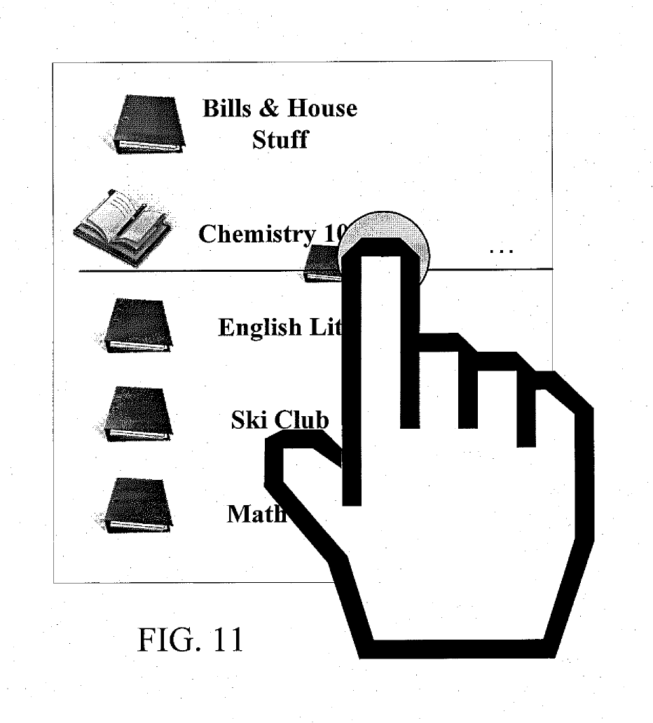

Of course, the same functionality can be performed in the sections column 226 and the notebooks column 224 as well. FIG. 10 shows that a user has placed the “lab” section navigation element 450 in the drag and drop mode by tapping it and then placing his or her finger 452 on it on the display. FIG. 11 shows that the user has done the same thing for the “Chemistry 101” notebook navigation element in notebook column 224.

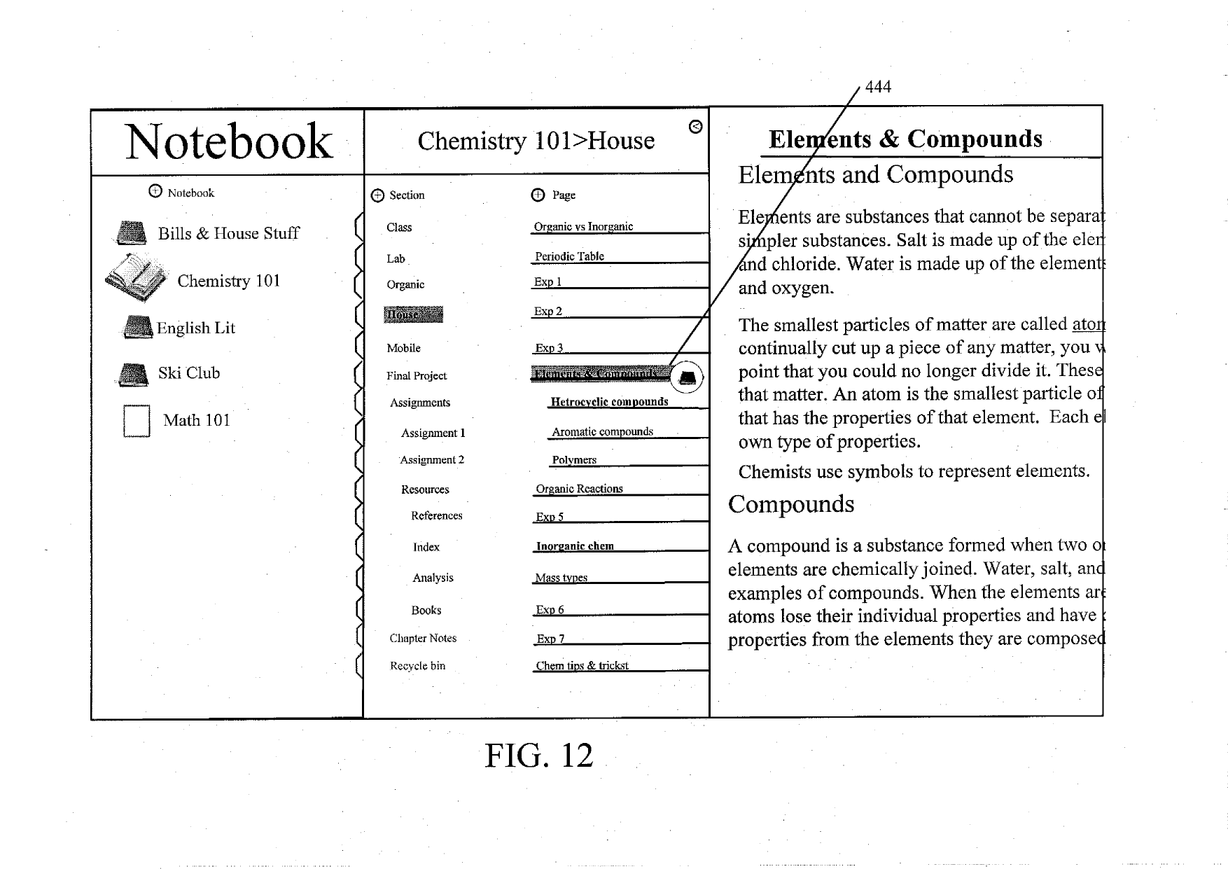

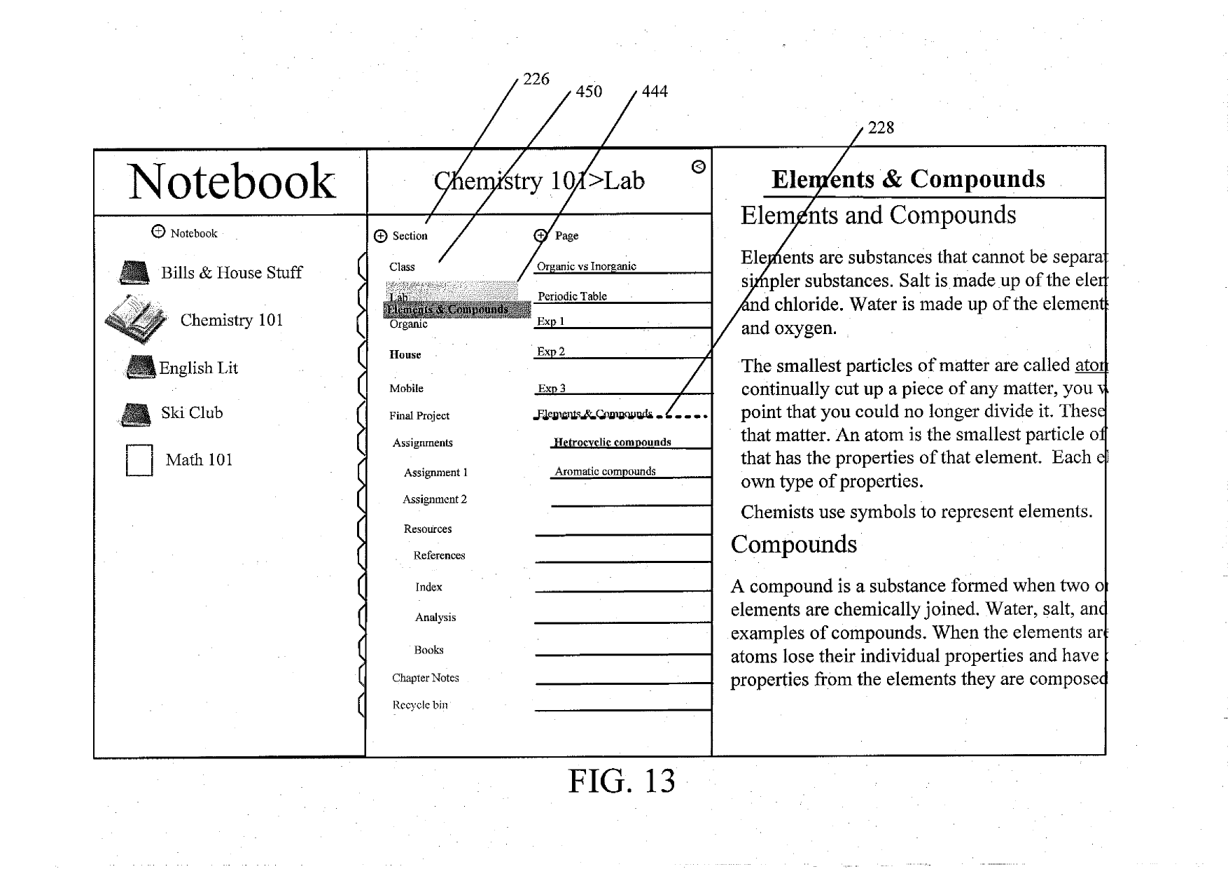

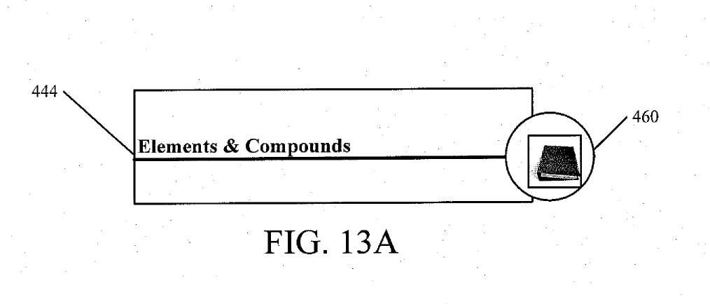

It should also be noted, in one embodiment, the user can drag and drop navigation elements across columns 224, 226 and 228. FIGS. 12 and 13 illustrate one example of this.

FIG. 12 shows that the user has placed the “Elements and Compounds” page navigation element 444 in the drag and drop mode.

FIG. 13 shows that the user has dragged the “Elements and Compounds” page 444 from the pages column 228 to the sections column 226, and specifically has moved it to a location just under the “Lab” section 450. In one embodiment, the shadow of the Elements and Compounds page 444 might not be displayed in the location shown in FIG. 13, until the user drops it there. Of course, this behavior can be varied as desired.

Assuming, however, that the user has moved the Elements and Compounds page navigation element 444 to a location just below the “Lab” section navigation element 450, the user can release it in the sections column 226 by lifting his or her finger off the page. This will cause the page list in column 228 to be updated by application 116 so that the display in column 228 shows the Elements and Compounds page 444 as a new page for the “Lab” section 450. It should be noted that the page 444 is still a page in column 228. It has simply been moved to become a page of the “Lab” section 450, instead of a page of the “House” section. FIG. 13 shows that the Lab section 450 has now been selected and that the “Elements and Compounds” page 454 shows up in the page list in column 228.

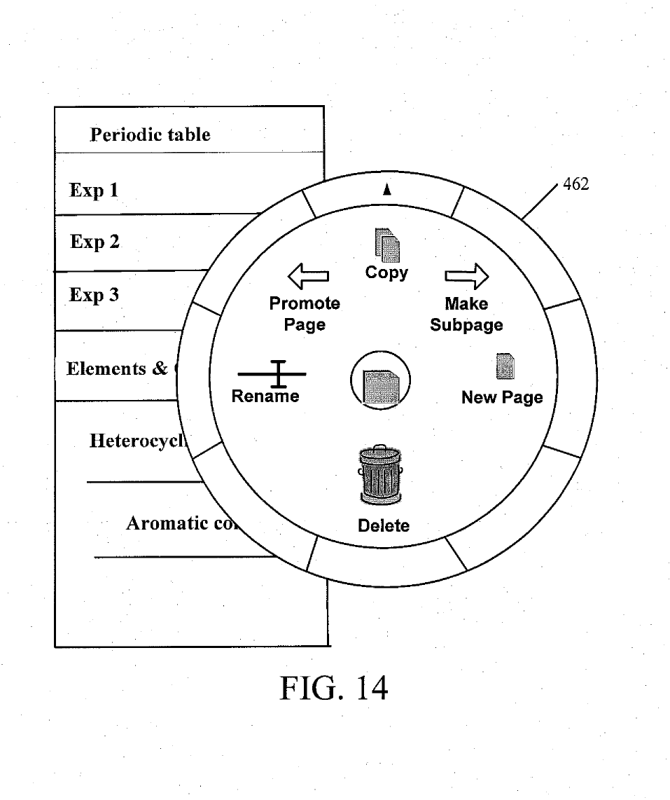

In another embodiment, a number of these functions can be performed using a secondary menu. For instance, when the user taps on a navigation element, this can cause an icon to appear on it. FIG. 13A shows an enlarged view of the “Elements and Compounds” page navigation element 444. When the user taps on navigation element 444, this causes an icon 460 to appear on element 444. Tapping on the icon 460 invokes a secondary menu, such as a radial menu 462 shown in FIG. 14. FIG. 14 shows that the radial menu has a plurality of different commands, which when selected, can display a list of subcommands as well. The commands and subcommands can be arranged as desired.

These are but a few of the user inputs on individual columns 224, 226 and 228, which can be taken. They are represented by block 290 in FIG. 1B.

It has been found that, in some embodiments, it can be helpful for the user to be able to quickly and easily view the most recently visited pages of content in note taking application 116. Therefore, in one embodiment, the user can input a gesture on a display (such as full navigation display 206 or any of the other navigation displays) to invoke thumbnail previews of the most recently visited pages. By way of example, in one embodiment, note taking application 116 stores a history for a given user in data store 150. The history indicates the specific notebooks, sections, and pages (and subpages) visited by a user. Therefore, when the user inputs the appropriate gesture (such as a downward gesture on the user interface display 206) this can invoke thumbnail functionality so that the user can review the most recently viewed pages. Receiving user input invoking thumbnail functionality is indicated by block 293 in FIG. 1B.

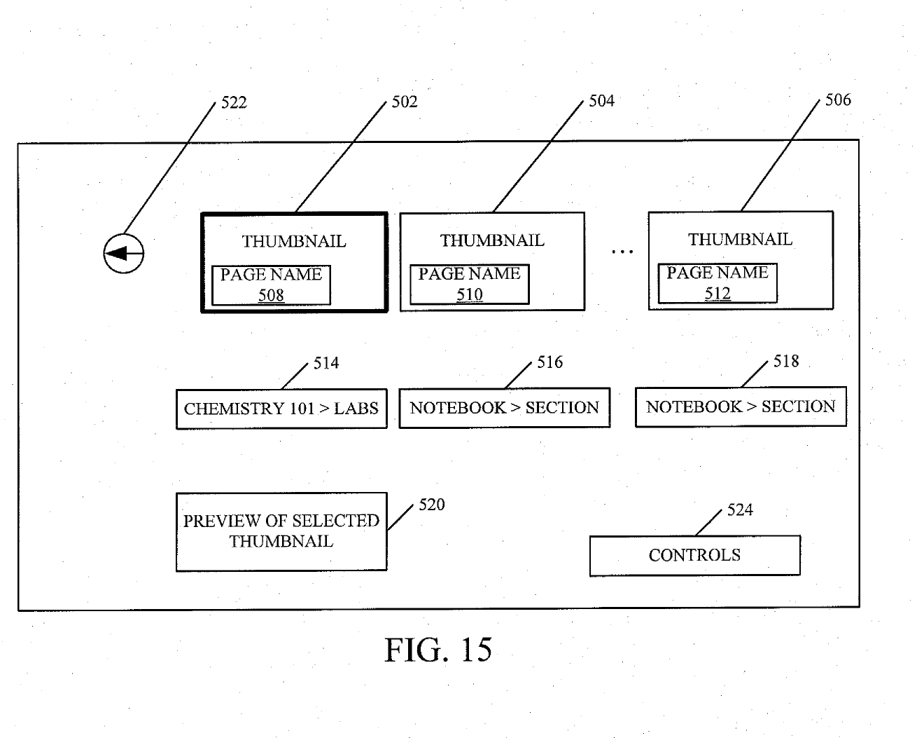

In response, note taking application 116 illustratively displays a preview or thumbnail of the most recently visited pages. This can be done by generating a user interface display, such as user interface display 500 shown in FIG. 15. FIG. 15 shows that display 500 includes a display of a plurality of thumbnails 502, 504 and 506 which represent the pages stored for this user in data store 150 by note taking application 116. In one embodiment, each thumbnail has a corresponding page name indicator 508, 510 and 512 which identify the particular page name corresponding to the associated thumbnail. In addition, each thumbnail 502-506 also illustratively includes a notebook and section indicator 514, 516 and 518 which identify the notebook and section where the particular page name for the thumbnail came from. By viewing the thumbnails 502-506 and the other indicators, the user can quickly and easily determine which notebooks the user has recently been visiting, which sections, and even which pages.

In accordance with one embodiment, user interface display 500 also includes a preview portion 520. In the embodiment shown, preview portion 520 shows a preview of one of these thumbnails 502-506 selected on the display. For instance, FIG. 15 shows that the user has selected thumbnail 502 by simply tapping on it or otherwise selecting it. This causes thumbnail 502 to appear in a different color or in bold, or in some other visually distinctive way to show that it has been selected. In that case, application 116 generates a preview of the selected thumbnail in display portion 520. If thumbnail 502 contains text or written notes, those notes are displayed in larger text in portion 520, so that the user can preview the text of the selected thumbnail.

In one embodiment, display 500 also includes a scroll mechanism 522 which allows a user to scroll through various thumbnails, if they cannot all be displayed at the same time. In addition, display 500 also illustratively includes a plurality of other user input controls or user input mechanisms 524 that allow the user to switch to thumbnails that were not the most recently visited, but are the most frequently visited, or that fulfill some other criteria, such as being user-defined thumbnails. In addition, controls 524 can allow the user to perform other control functions with respect to thumbnails 502-506 as well. Controls 524 also illustratively allow a user to define certain pages that are to be included in the thumbnails. Therefore, even if they are not the most recently visited or most frequently visited, the user can simply define them to be included in the thumbnails, and application 116 will include thumbnails of those pages for user review as well. Showing the thumbnails 502-506 is indicated by block 294 in FIG. 1B.

If the user double taps or otherwise actuates one of the thumbnails, or the page indicator 508, or the notebook and section indicator 514, this causes application 116 to navigate the user to the appropriate spot in the notebook. Navigating to any desired page, section, or notebook is indicated by block 295 in FIG. 1B.

It should be noted that the thumbnail functionality can be very helpful particularly where a user is frequently switching between different sections or notebooks. Instead of selecting a new notebook, panning to the desired section and page, the user can quickly invoke the thumbnail functionality and navigate between two pages that are in different sections, or even in different notebooks, very easily.

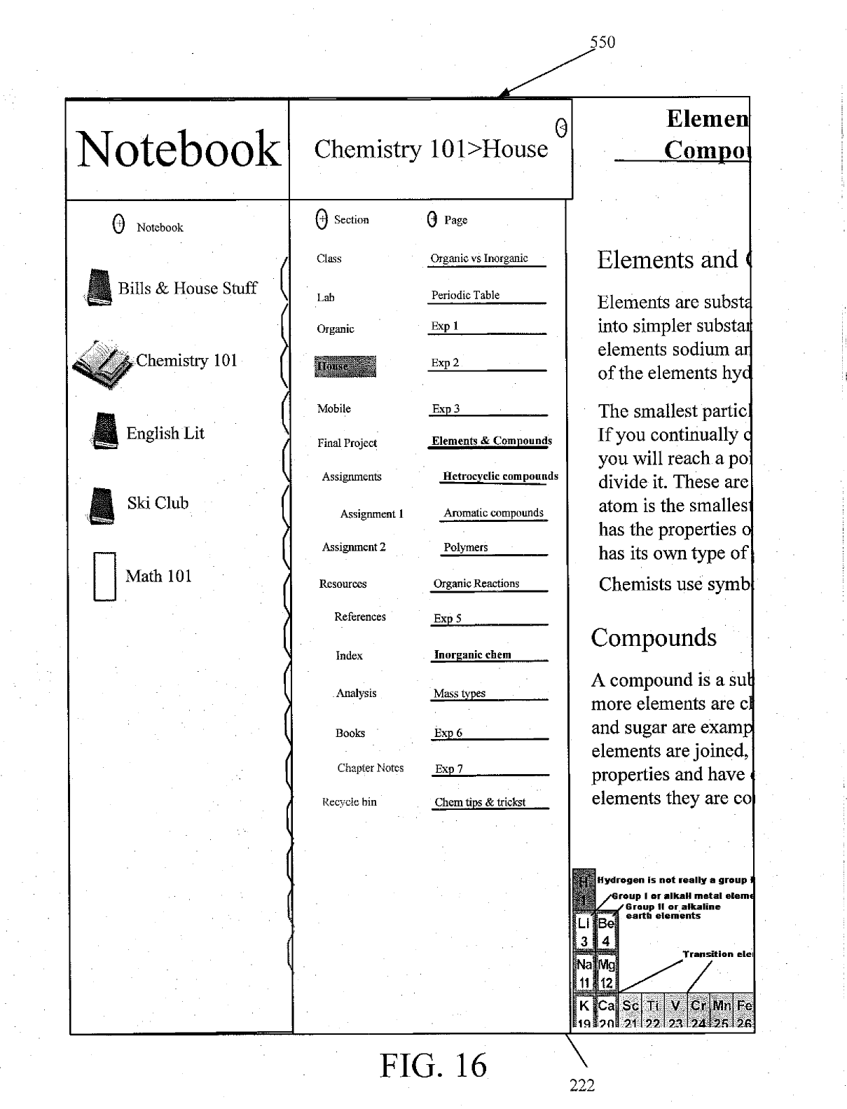

In another embodiment, the user can illustratively provide either an explicit or implicit input to note taking application 116 to cause the displays to be generated in portrait orientation. This can be done explicitly through activation of a displayed user interface mechanism, or it can be done implicitly, such as by rotating the device displaying the view. When the device is rotated, application 116 detects this rotation using, for example, a gyroscope or other orientation sensor. This is indicated by block 296 in FIG. 1B. If that input is received, application 116 changes the displays to portrait orientation as indicated by block 297 in FIG. 1B. FIGS. 16-18 show user interface displays that illustrate this in more detail.

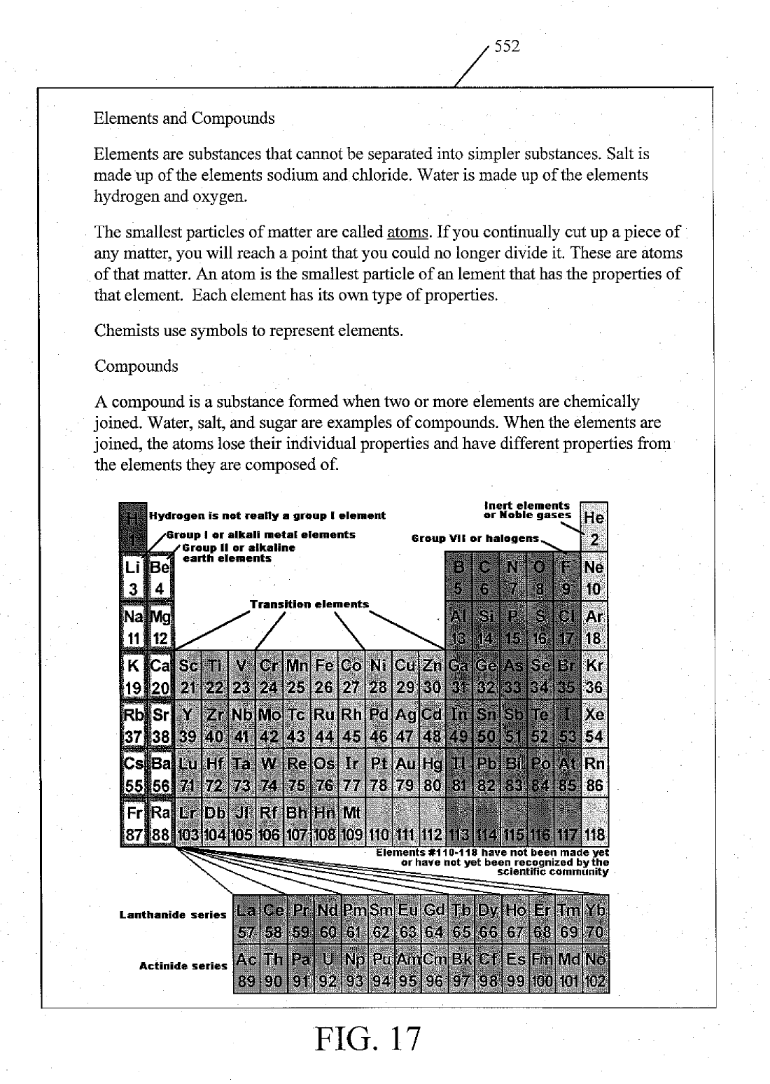

FIG. 16 shows a display 550, which is similar to the full navigation display 206 discussed with respect to the previous Figures, except that it is shown in portrait orientation. Similar items are similarly numbered to those shown in FIG. 3. It can be seen, however, that the content portion 222 now contains only the left most side of the content page, but it also includes more information along the vertical axis. By simply tapping on content page 222, this causes application 116 to generate the full page view 212, but in the portrait orientation. This is indicated by display 552 shown in FIG. 17. It can be seen that more pages are visible in the full page view 552 than in the full page view 212 discussed above. However, less content on an individual page is visible as well. In one embodiment, if the user taps on the page in the full page view 552, application 116 will generate the display in the full page view, but in the landscape view as shown above with respect to view 212.

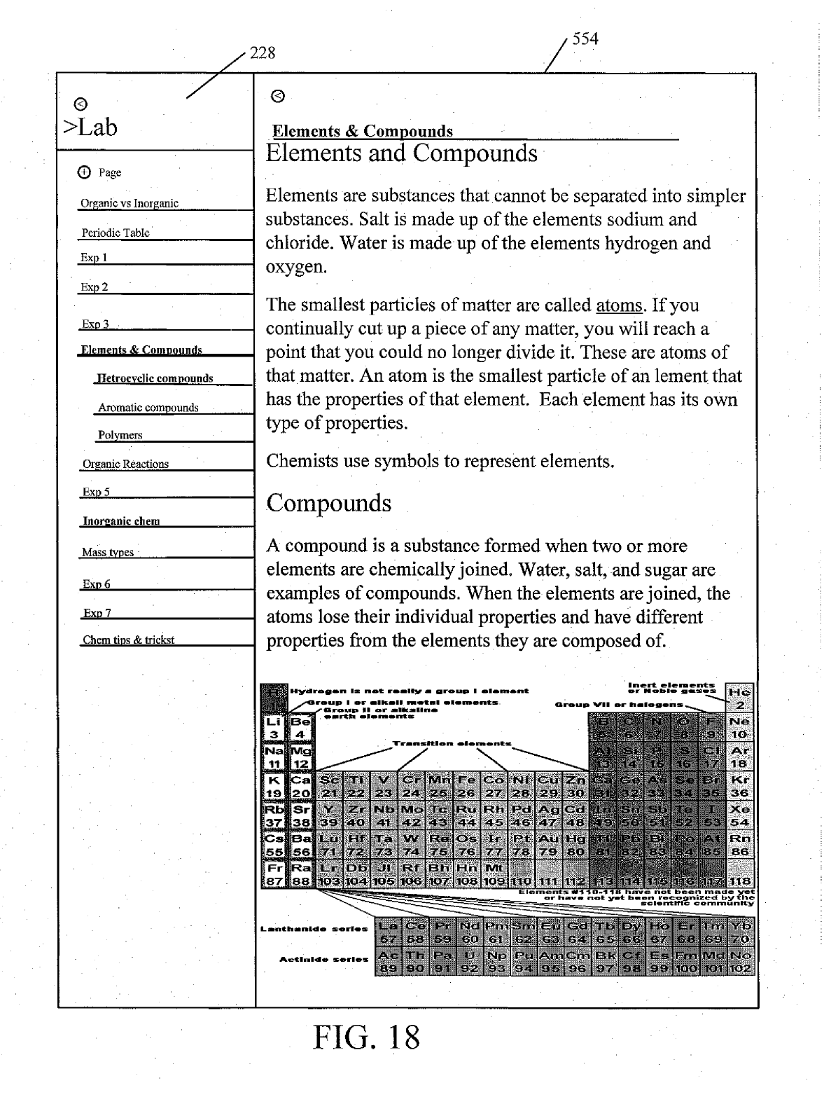

Of course, from either view 550 or 552 shown in FIGS. 16 and 17, the user can navigate to either the intermediate navigation view or the mini navigation view in the portrait orientation. FIG. 18 shows a mini navigation view 554 in the portrait orientation. It can be seen that content portion 222 is displayed, along with page column 228. This is similar to mini navigation view 210, except that it is in portrait orientation.

In accordance with one embodiment, a notebook 118 that is being operated on by a user 108 and is stored remotely, may need to be synchronized based on edits or other inputs provided by user 108, or other collaborators on the given notebook 118. In that case, a user can invoke a synchronization operation, or note taking application 116 can begin a synchronization operation automatically. When this is invoked, application 116 generates a synchronization status display. This is indicated by blocks 298 and 299 in FIG. 1B. A secondary menu can be invoked from the notebook column 224 and the synchronization operation can be invoked from the secondary menu.

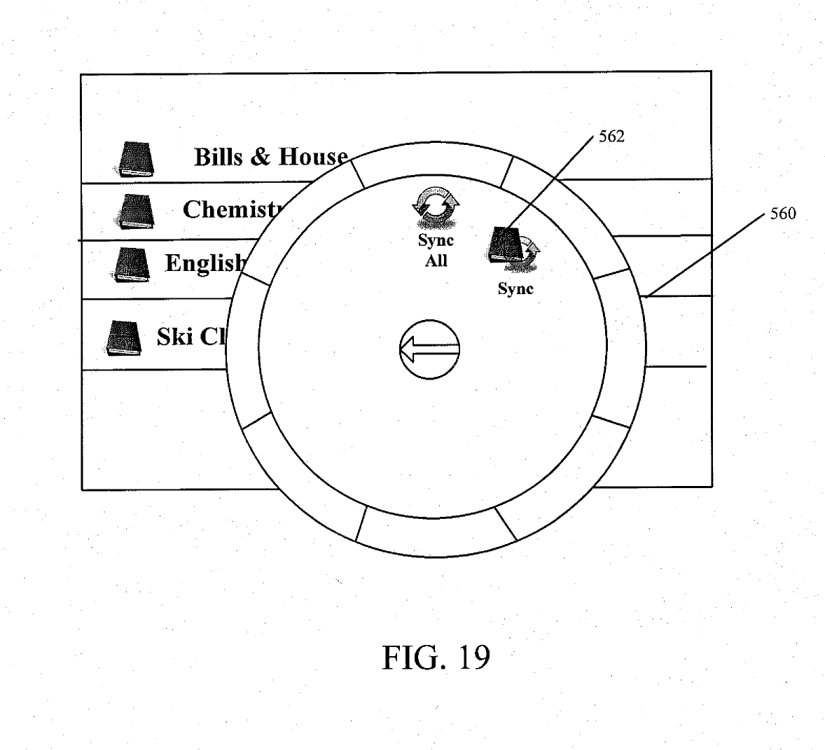

FIG. 19 shows one embodiment of a radial menu 560 that can be invoked by double tapping or pressing and holding, on a notebook icon in notebook column 224. It can be seen that radial menu 560 has a “sync” command 562 that can be invoked by the user. Of course, other mechanisms can be used to invoke a synchronization operation as well.

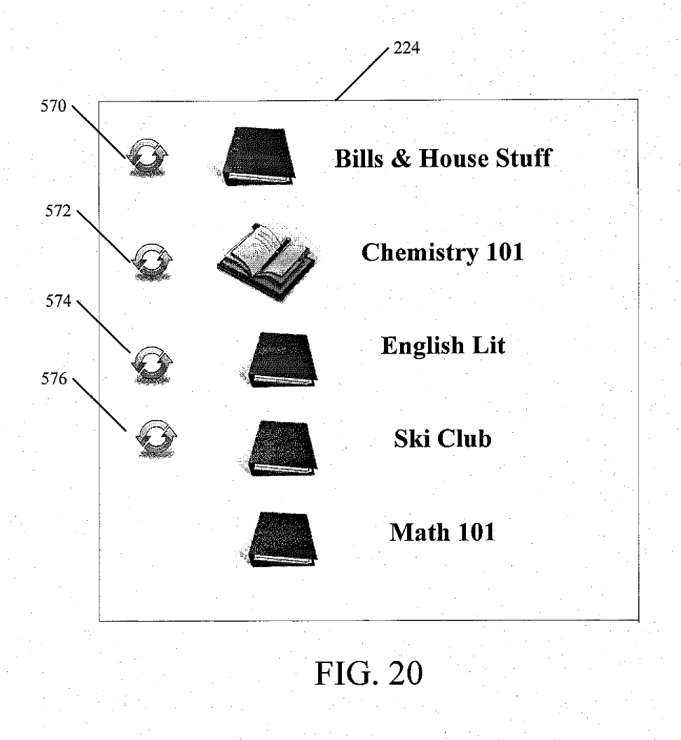

In any case, in one embodiment, note taking application 116 illustratively displays the synchronization status automatically, next to each notebook icon in notebook column 224 in the full navigation view 206. FIG. 20 shows one embodiment of this type of display.

FIG. 20 shows a plurality of synchronization indicators 570, 572, 574 and 576 adjacent four of the notebooks in notebook column 224. In one embodiment, indicators 570-576 are) animating (e.g., rotating during synchronization of the corresponding notebook. When the animation stops and the indicator disappears, this indicates that the synchronization process has been successful.

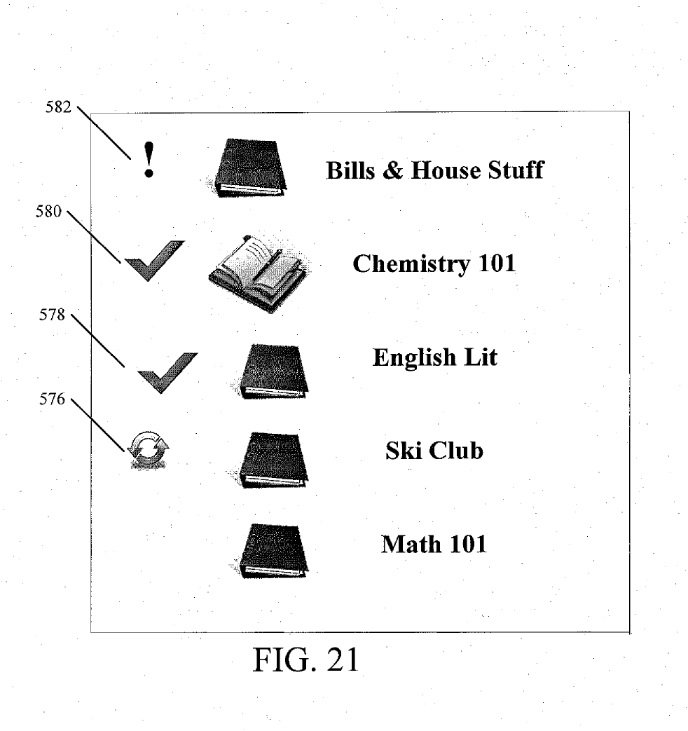

FIG. 21 shows another embodiment in which synchronization success and errors are displayed. It can be seen that the “Ski Club” notebook has the synchronization status indicator 576 that shows that the notebook is being synchronized. In the embodiment shown in FIG. 21, the English Lit notebook and the Chemistry 101 notebook have success indicators 578 and 580 associated with them, indicating that they have been synchronized. The “Bills and House Stuff” notebook has an error indicator 582 indicating that there is a synchronization error. It can easily be seen from FIG. 21 that the synchronization status of each notebook is given in the context of the notebook. This provides an easy indication to the user as to whether a given notebook is up-to-date, is being synchronized, or has synchronization errors associated with it. In another embodiment, if the error indicator 582 is displayed proximate a notebook icon, the user can tap on the error indicator 582 and get a more detailed indication of what types of error have occurred and where they have occurred in the notebook.

Finally, other processing can also be performed based on user inputs. This is indicated by block 301 in FIG. 1B.

Notebook creation will now be discussed in more detail. As mentioned above with respect to FIG. 3, each of the pannable columns 224, 226, and 228 have a user input mechanism 300, 302 and 304, respectively. These user input mechanisms can be used to create a new notebook, a new section within a notebook, and a new page within a section, respectively. Creation of a new notebook will be discussed first.

As also discussed above, user input mechanism 300 is an actuable user input mechanism (i.e., one that can be activated by the user), such as a button, which can be actuated by the user to create a new notebook. It is generally located at the top of the notebook column 224 shown in FIG. 3, but it could be located in other positions as well.

Upon actuating button 300, the user interface component generates a display, such as that shown in FIG. 22. It will be appreciated that FIG. 22 only shows the notebook column 224, and the other columns may be displayed as well. However, for the sake of simplicity, only column 224 is shown in FIG. 22.

As illustrated in FIG. 22, a “new notebook” field is generated at the bottom of the list of open notebooks in column 224. It is illustratively provided in a default notebook color and it includes a notebook name text entry field 602 along with an account type and user name field 604. In one embodiment, note taking application 116 permanently ties the new notebook identified in field 602 to the first (and/or primary) cloud service account that has been added by the user in application 116. If the user removes that account, then the next oldest cloud service account (based upon the date added) can be used. Of course, in another embodiment, field 604 is editable by the user to tie the new notebook named in field 602 to another cloud service account as well. In one embodiment, the account type and user name field 604 is also provided with a dropdown button 605. When dropdown button 605 is actuated by the user, a dropdown menu is generated that displays all account types will all user names generated by this user. The user can simply select from the dropdown menu to populate field 604. In addition, the dropdown menu may include an “Add Account” button which, when actuated by the user, allows the user to add a new account and assign the new notebook to that account as well. FIG. 22 also shows, like other text boxes, that notebook name field 602 can have a corresponding “clear” user input mechanism 606. This can be actuated by the user to clear field 602.

FIG. 22 also shows that, in one embodiment, a user input mechanism, such as keyboard 608, is displayed for the user to input the textual items in field 602, and optionally field 604. FIGS. 22A and 22B illustrate a flow diagram showing one embodiment for creating a new notebook. Receiving the user input to start creating a new notebook is indicated by block 749 and generating the display shown in FIG. 22 is indicated by block 751. Automatically assigning the account type is indicated by block 753. In the embodiment shown in FIG. 22, the cursor 610 automatically appears in the first space of the notebook name field 602, so that the user can quickly and easily type in the name of the new notebook in field 602.

At this point, there are different ways of proceeding. For instance, application 116 can automatically choose a default name for the first section in the new notebook. The default name can be chosen randomly, or using a pre-defined naming convention, or otherwise. The user can then proceed to create and open other sections or to create and open pages, etc. Alternatively, application 116 can provide more assistance to the user in setting up the new notebook. This embodiment is described below, but it is only one illustrative example.

Once the user has entered the appropriate information to create a new notebook, application 116 then generates a user interface display that allows the user to create and name a first section in the new notebook, so that the user can begin using the new notebook as quickly as possible. This is indicated by block 755 in FIG. 22A. Once a section is created, application 116, optionally generates a user interface display that allows the user to create a first page in that section. This is indicated by block 757 in FIG. 22B. Once the first page has been named and created by the user, the user is able to begin taking notes on that page, in the newly created section, of the newly created notebook. This is indicated by block 759. Of course, the user is also offered the option to create additional notebooks, before moving on to the section creation, as indicated by blocks 761 and 763. In addition, the user is offered the option to create more than one section in a notebook, before naming pages, as indicated by blocks 765 and 767. The user is also offered the opportunity to name more pages, before taking notes on a given page, as indicated by blocks 769 and 771. However, in one embodiment, the user is automatically moved from creating a new notebook to creating a new section to creating a new page, to editing or taking notes on that page. The user can opt out of this sequence, as discussed above.

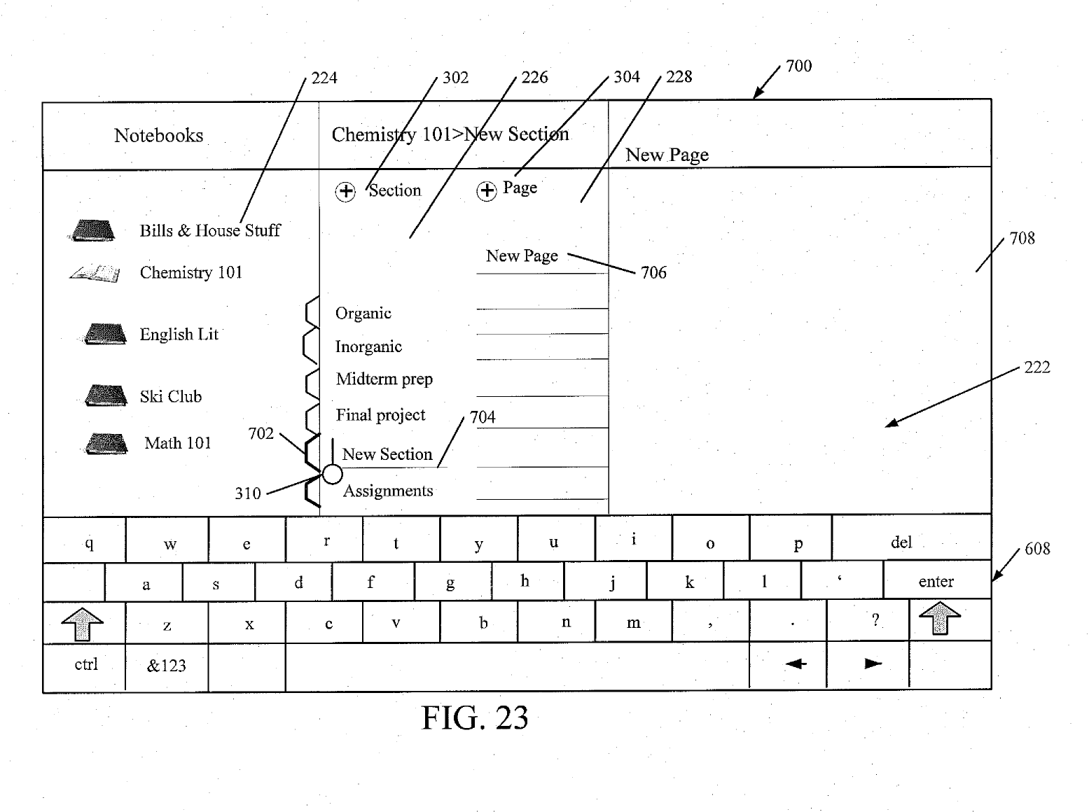

FIG. 23 illustrates a user interface display 700 that can be generated by the user interface component to allow a user to create a new section. When the user actuates the new section button 302, a new section tab 702 is illustratively created and displayed after the last section of the parent of the selected section. Also, application 116 illustratively generates a user interface display using the user interface component to show keyboard 608, and places the cursor 610 on the section name field 704 so that the user can quickly and easily enter the name of the new section. Once the user has entered the name, and taps on it, or otherwise commits to the name, the user can then tap on a new page field 706 that is also automatically generated. This moves the cursor 610 to the new page field 706 so that the user can then name a page for the newly created section corresponding to tab 702. Once the user commits to the page name, application 116 illustratively moves cursor 610 to a new page 708 that is generated in the content portion 222 of the display. This allows the user to quickly begin taking notes or adding content to the newly created page in the newly created section.

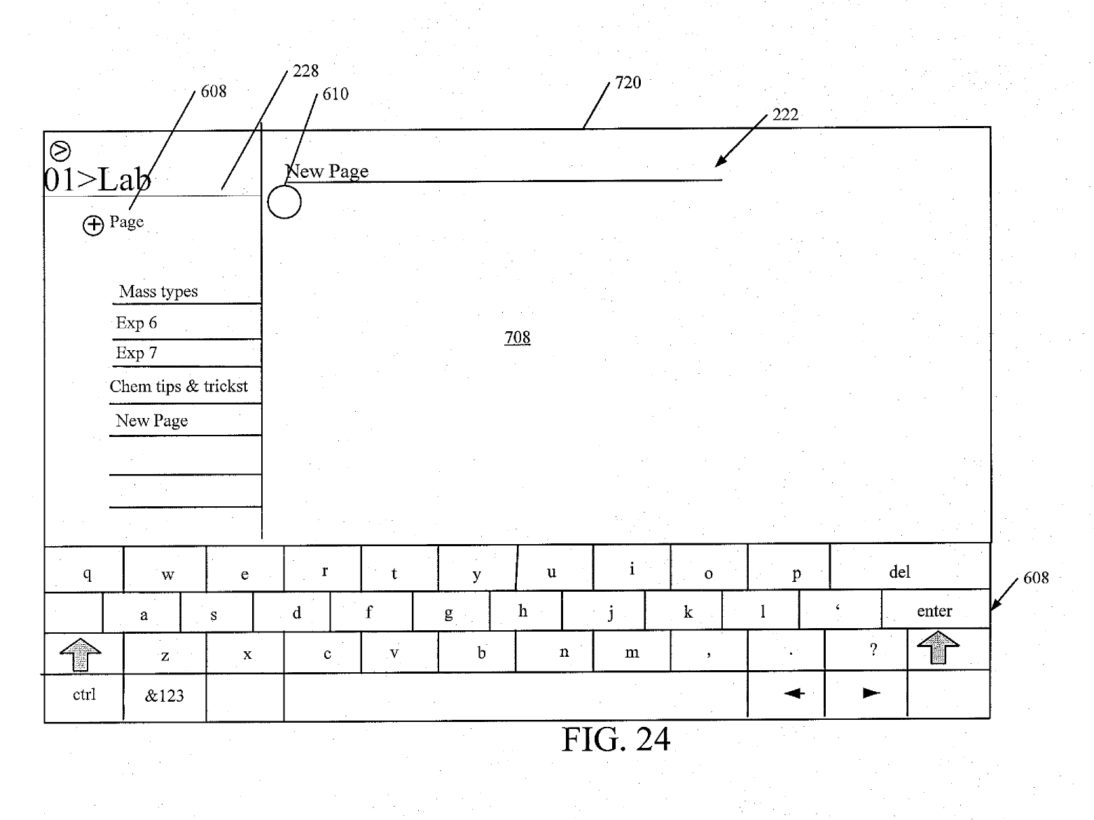

FIG. 24 shows this last step in more detail. FIG. 24 shows a user interface display 720 that is generated once the user taps on the new page field 704 in new page column 228. Tapping the new page field (or its corresponding icon) creates a new page at the bottom of the page list in column 228 and shifts the display to the left (in the embodiment shown in FIG. 24, it shifts the display to the mini navigation field 210, and also brings up keyboard 608 and moves cursor 610 onto the new page in the content portion 222 of the display.

It will be noted that different or additional columns could be used as well. For instance, in one embodiment, another column (a section group column) is added between the sections column and the pages column. The new column shows contents of a section group. If a section group is selected in the section column, its contents are displayed in the section group column. Further, if a section group is selected from the section group column, an additional column can be displayed showing the contents of that section group. These are just examples of additional columns and others can be used as well.

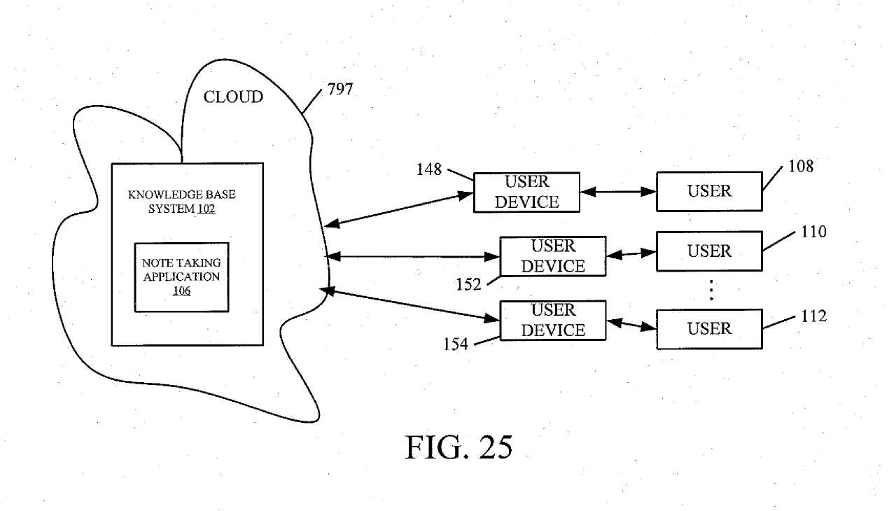

FIG. 25 shows an embodiment in which system 102 and application 116 are deployed in a cloud computing environment. FIG. 25 shows these components in cloud 797. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 102 or application 116 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client device 16 directly, or in other ways.

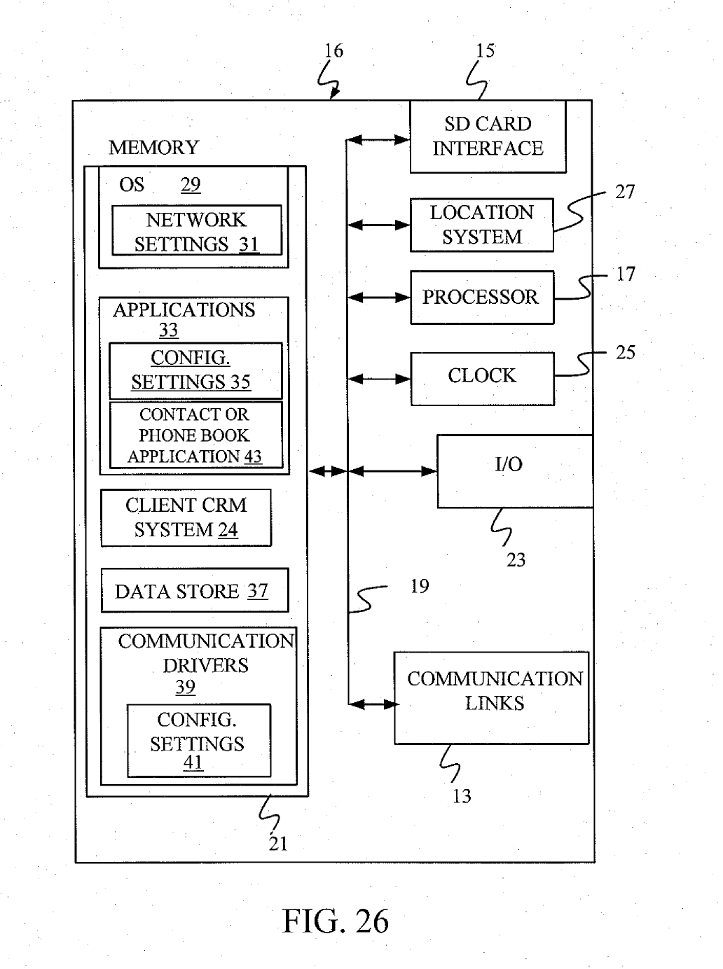

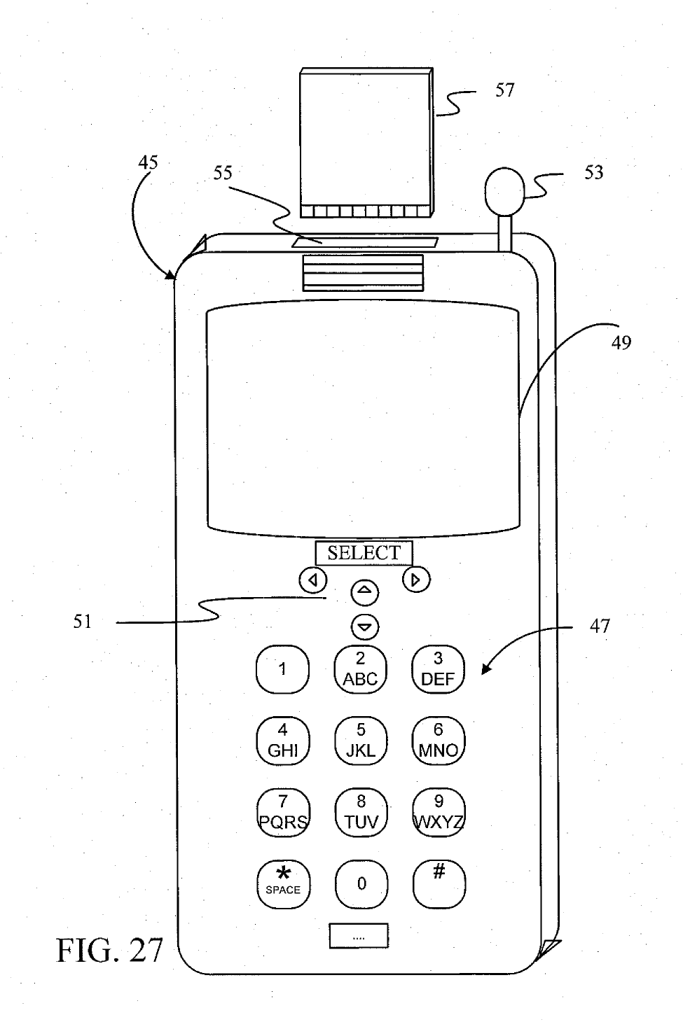

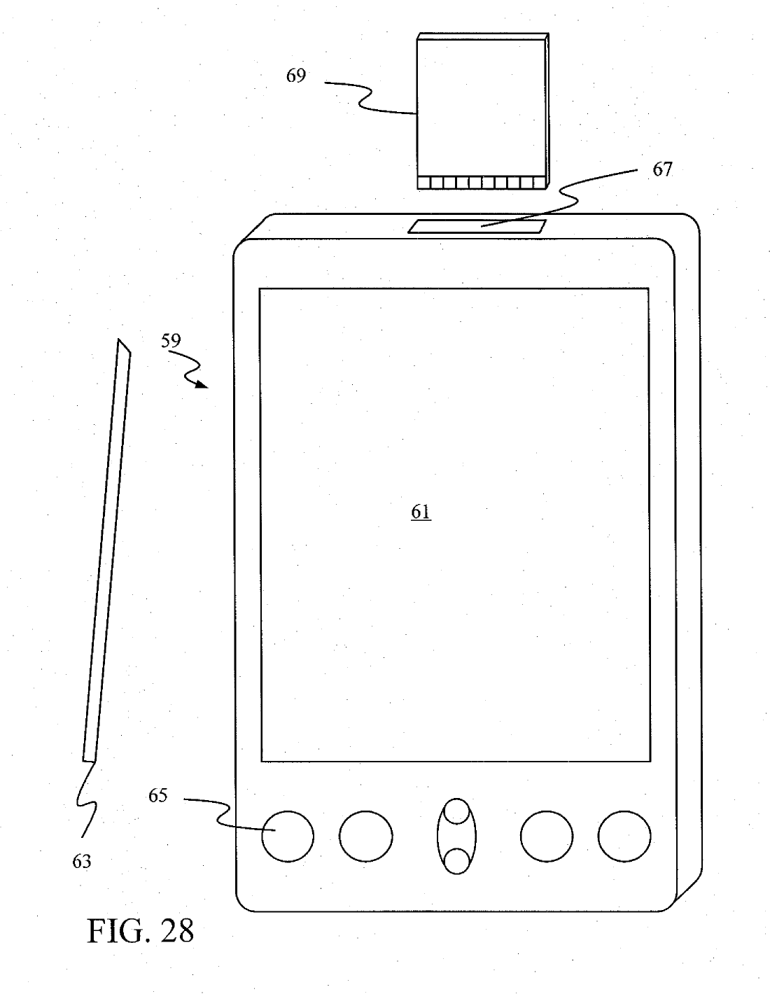

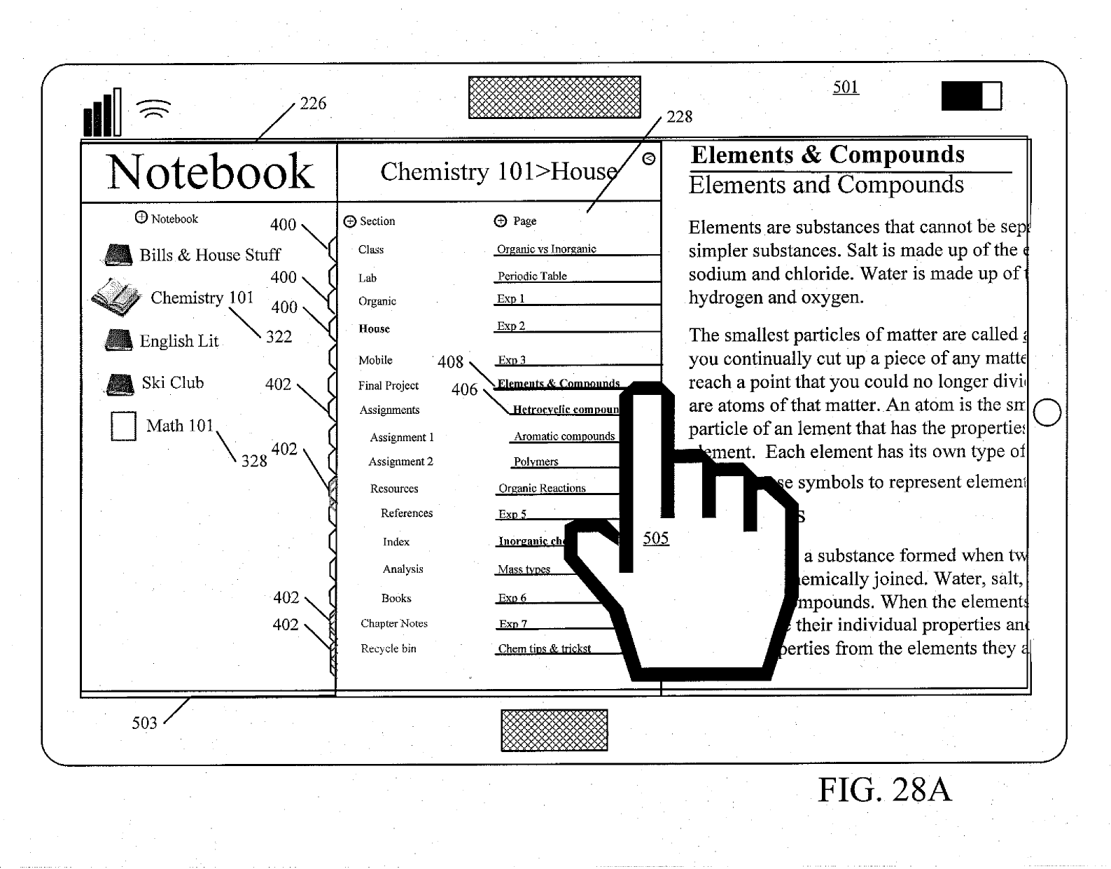

In any case, FIG. 26 is a simplified block diagram of one illustrative embodiment of a handheld or mobile computing device that can be used as device 16 (which can be devices 148, 152 and 154), in which the present system can be deployed. FIGS. 27 and 28 are examples of handheld or mobile devices.

FIG. 26 provides a general block diagram of the components of a device 16 that can run components of system 102 or that interacts with system 102, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 14 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 14.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 9, network settings 11, applications 43, application configuration settings 35, data store 37, communication drivers 39, and communication configuration settings 7. Memory 21 can include all types of tangible volatile and non-volatile computer-readable memory devices. It can also include computer storage media (described below). Memory 21 stores computer readable instructions that, when executed by processor 14, cause the processor to perform computer-implemented steps or functions according to the instructions. Drawing program 12, or other items for example, can reside in memory 21. Processor 14 can be activated by other components to facilitate their functionality as well.

Examples of the network settings 7 include things such as proxy information, Internet connection information, and mappings. Application configuration settings 7 include settings that tailor the application for a specific enterprise or user. Communication configuration settings 41 provide parameters for communicating with other computers and include items such as GPRS parameters, SMS parameters, connection user names and passwords.

Applications 43 can be applications that have previously been stored on the device 10 or applications that are installed during use, although these can be part of operating system 9, or hosted external to device 16, as well.

FIGS. 27 and 28 provide examples of devices 16 that can be used, although others can be used as well. In FIG. 28, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 28 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 10 are possible. Examples include tablet computing devices, music or video players, and other handheld computing devices.

FIG. 28A shows one embodiment of the multi-column display on a tablet computer. In FIG. 28A, application 116 is implemented on a tablet or slate computer 501. Computer 501 is shown with user interface display 206 displayed on the display screen 503. Screen 503 can be a touch screen (so touch gestures from a user's finger 505 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 501 can also illustratively receive voice inputs as well.

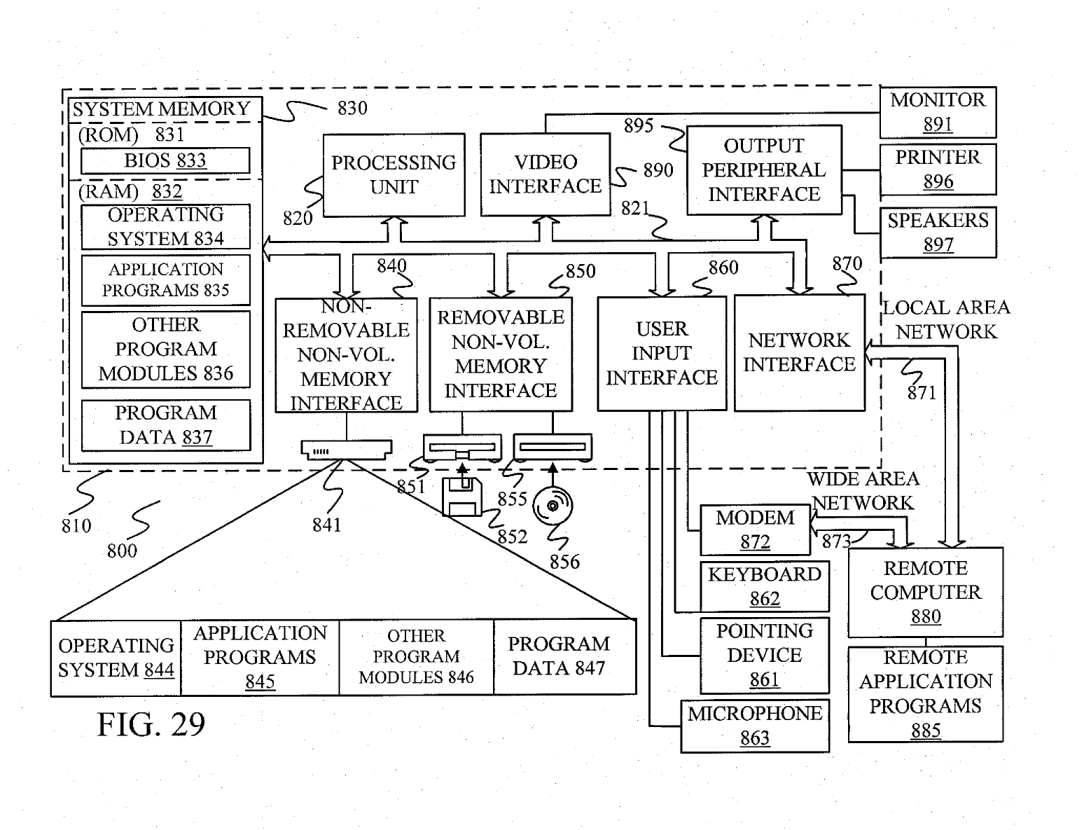

FIG. 29 is one embodiment of a computing environment in which device 16, devices 148, 152 and 154, system 102 or application 116 (for example) can be deployed. With reference to FIG. 28, an exemplary system for implementing some embodiments includes a general-purpose computing device in the form of a computer 810. Components of computer 810 may include, but are not limited to, a processing unit 820 (which can comprise processor 146), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 29.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 29 illustrates operating system 834, application programs 835, other program modules 836, and program data 837.

The computer 810 may also include other removable/non-removable volatile/nonvolatile computer storage media. By way of example only, FIG. 29 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 29, provide storage of computer readable instructions, data structures, program modules and other data for the computer 810. In FIG. 28, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. They can also include search components 802 and 804.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 29 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 29 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of processing content in a note taking application, comprising:
generating a multi-column user interface display that displays information in a set of navigation columns comprising a notebook navigation column listing notebook navigation elements corresponding to different notebooks in the note taking application, a section navigation column listing section navigation elements corresponding to sections in a notebook selected in the notebook navigation column, a page navigation column listing page navigation elements corresponding to pages in a selected section in the section navigation column and in a content display portion displaying content corresponding to a selected page in the page navigation portion, the multi-column user interface display having a notebook creation user input;
receiving actuation of the notebook creation user input; and
automatically displaying a new notebook navigation element in the notebook navigation column along with a text entry field and a text entry user input mechanism that receives user text inputs to name the new notebook.

2. The computer-implemented method of claim 1 wherein generating a multi-column user interface display comprises:
displaying the notebook creation user input in the notebook navigation column.

3. The computer-implemented method of claim 1 and further comprising:
in response to receiving a notebook name for the new notebook, automatically displaying a new section navigation element, defining a new section corresponding to the new notebook, in the section navigation column.

4. The computer-implemented method of claim 3 wherein automatically displaying the section navigation element comprises:
displaying a text field that receives user text inputs naming the new section.

5. The computer-implemented method of claim 4 and further comprising:
in response to receiving a section name for the new section, automatically displaying a new page navigation element, defining a new page corresponding to the new section, in the page navigation column.

6. The computer-implemented method of claim 5 and further comprising:
displaying a new page corresponding to the new page navigation element, in the content display portion; and
placing a cursor on the new page to receive user content inputs to the new page.

7. The computer-implemented method of claim 1 and further comprising:
receiving a user input to open an existing notebook in the note taking application.

8. The computer-implemented method of claim 7 wherein automatically displaying a new notebook navigation element comprises:
automatically assigning the new notebook to an account and user name for the existing notebook; and
displaying the account and user name adjacent the text entry field for the new notebook navigation element.

9. The computer implemented method of claim 7 wherein automatically displaying a new notebook navigation element comprises:
when the user has multiple accounts, displaying a drop down menu of the user's accounts;
receiving a user's selection of one of the displayed accounts; and
assigning the new notebook to the selected one of the displayed accounts.

10. A note taking system, comprising:
a note taking application that generates a multi-column user interface display that displays information in a set of navigation columns comprising a first navigation column and a second navigation column and in a content display portion, the columns being displayed so the first navigation column has first selectable navigation elements that, when actuated, cause the note taking application to navigate to a first location in a notebook, and the second navigation column has second selectable navigation elements corresponding to a selected one of the first selectable navigation elements, the second selectable navigation elements, when actuated, causing the note taking application to navigate to a second location in the notebook, within the first location, the first navigation column having a first user input mechanism actuable to create a new first selectable navigation element and the second navigation column having a second user input mechanism actuable to create a new second selectable navigation element, the note taking application receiving actuation of the first user input mechanism and automatically generating a new first user navigation element in the first navigation column; and
a computer processor being a functional component of the system and activated by the note taking application to facilitate generating the multi-column user interface display and generating the new first user navigation element.

11. The note taking system of claim 10 wherein the information in the first and second navigation columns is hierarchically related.

12. The note taking system of claim 10 wherein the note taking application generates the first new navigation element by displaying a name field that receives a user text input naming the first new navigation element.

13. The note taking system of claim 12 wherein the note taking application, in response to receiving the name for the first new navigation element, automatically generates a second new navigation element in the second navigation column.

14. The note taking system of claim 13 wherein the note taking application generates a second new navigation element in the second navigation column by displaying a name field that receives a user text input naming the second new navigation element.

15. The note taking system of claim 14 wherein the note taking application, in response to receiving the name for the second new navigation element, automatically generates a new content page in the content display portion.

16. The note taking system of claim 15 wherein the note taking application automatically generates the new content page by placing a cursor on the new content page to receive textual content on the new content page.

17. The note taking system of claim 10 wherein the multi-column user interface display further comprises:
a third navigation column having third navigation elements hierarchically related to the first and second navigation elements.

18. The note taking system of claim 17 wherein the third navigation column includes a third user input mechanism actuable to create a new third navigation element in the third navigation column.

19. The note taking system of claim 18 wherein the first navigation column comprises a section navigation column having section navigation elements, the second navigation column comprises a page navigation column having page navigation elements and wherein the third navigation column comprises a notebook navigation column having notebook navigation elements each specifying a different notebook in the note taking application, the section navigation elements specifying sections in a notebook corresponding to a selected notebook navigation element and the page navigation elements specifying pages for a section corresponding to a selected section navigation element.

20. A computer readable medium having computer readable instructions which, when executed by a computer, cause the computer to perform a method, comprising:
generating a multi-column user interface display that displays information in a set of navigation columns comprising a notebook navigation column listing notebook navigation elements corresponding to different notebooks in the note taking application, a section navigation column listing section navigation elements corresponding to sections in a notebook selected in the notebook navigation column, a page navigation column listing page navigation elements corresponding to pages in a selected section in the section navigation column and in a content display portion displaying content corresponding to a selected page in the page navigation portion, the notebook navigation column having a notebook creation user input;
receiving actuation of the notebook creation user input; and
automatically displaying a new notebook navigation element in the notebook navigation column along with a text entry field and a text entry user input mechanism that receives user text inputs to name the new notebook;
in response to receiving a notebook name for the new notebook, automatically displaying a new section navigation element, defining a new section corresponding to the new notebook, in the section navigation column.
